(19) United States
(12) Patent Application Publication
(10) Pub. No.: US 2014/0292602 A1
(43) Pub. Date: Oct. 2, 2014

(54) MULTIBAND ANTENNA AND MOBILE TERMINAL

(71) Applicants: Masaki Suzuki, Kakegawa-shi (JP); Shinichiro Kitano, Kawasaki-shi (JP)

(72) Inventors: Masaki Suzuki, Kakegawa-shi (JP); Shinichiro Kitano, Kawasaki-shi (JP)

(73) Assignees: NEC CASIO MOBILE COMMUNICATIONS, LTD., Kawasaki-shi, Kanagawa (JP); NEC AccessTechnica, LTD., Kakegawa-shi, Shizuoka (JP)

(21) Appl. No.: 14/359,852

(22) PCT Filed: Sep. 10, 2012
(86) PCT No.: PCT/JP2012/005726

§ 371 Date: May 21, 2014

(30) Foreign Application Priority Data
Nov. 22, 2011 (JP) 2011-254754

(51) Int. Cl. H01Q 9/04

(52) U.S. Cl. CPC H01Q 9/04
USPC 343/749

(57) ABSTRACT

The antenna has a configuration in which three inductors, i.e., first to third inductors 5 to 7 having values of inductances L1 to L3, respectively, are arranged in an inverted F-shaped antenna formed of miniaturized four antenna elements, i.e., first to fourth antenna elements 1 to 4 with an element length shorter than that of each wavelength of desired resonance frequencies are grounded at a GND ground point 11. A power feeding unit 10 feeds electric power to the inverted F-shaped antenna through a matching circuit 9, thereby enabling a plurality of antenna operations of a two-resonance loop antenna that resonates at two resonance frequencies on a high-frequency side, an inverted F-shaped antenna that resonates at two resonance frequencies on a low-frequency side, and an inverted L-shaped antenna.

### TECHNICAL FIELD

The present invention relates to a multiband antenna and a mobile terminal, and more particularly, to a miniaturized antenna which is mounted in a mobile terminal, such as a mobile phone or a smartphone, and covers multiple bands.

### BACKGROUND ART

Recently, with the rapid widespread of smartphones as well as mobile phones, the amount of data downloaded through mobile terminals has significantly increased. To deal with the increase of the data traffic, the traffic is distributed to a plurality of frequency bands, or new communication standards, such as LTE (Long Term Evolution), are adopted. Thus, the frequencies to be used have been increasingly diversified.

The frequency bands used differ from country to country. Considering the use of mobile terminals overseas, it is necessary that the mobile terminals cover an extremely large number of frequency bands. As a means to deal with this, a broadband antenna or a multiband antenna can be adopted. As means to obtain a broadband antenna, techniques are disclosed in “MULTIBAND ANTENNA AND RADIO COMMUNICATION TERMINAL” of Patent Literature 1 (Japanese Unexamined Patent Application Publication No. 2010-10960) and “MULTIBAND ANTENNA DEVICE AND PORTABLE RADIO EQUIPMENT USING THE SAME” of Patent Literature 2 (Japanese Unexamined Patent Application Publication No. H11-88032). According to the techniques disclosed in this literature, a resonant circuit is incorporated in the middle of an antenna element to thereby broaden the antenna characteristics in terms of bandwidth. However, even when such means is used, a broadband antenna capable of covering a wide band of 704 MHz to 2170 MHz, which is a frequency band used for mobile terminals, is impossible to realize.

As means to obtain a multiband antenna, “MULTIBAND ANTENNA DEVICE AND COMMUNICATION TERMINAL DEVICE” of Patent Literature 3 (Japanese Unexamined Patent Application Publication No. 2007-123982) discloses means for generating three resonances by mounting three antenna elements in an inverted F-shaped antenna. However, there are problems that the antenna is increased in size due to the mounting of three antenna elements; the antenna cannot cover all the frequency bands used for mobile terminals; and the antenna cannot generate four or more resonances.

Therefore, at present, the arrangement of a plurality of antenna elements is the only means to cover multiple bands, resulting in an increase in the size of mobile terminals. Accordingly, it is imperative to develop a miniaturized multiband antenna.

### CITATION LIST

### Patent Literature

[Patent Literature 1] Japanese Unexamined Patent Application Publication No. 2010-10960 (pp. 5-6)
[Patent Literature 2] Japanese Unexamined Patent Application Publication No. H11-88032 (pp. 4-6)
[Patent Literature 3] Japanese Unexamined Patent Application Publication No. 2007-123982 (pp. 3-5)

### SUMMARY OF INVENTION

### Technical Problem

As described above, the current techniques have a problem that the arrangement of a plurality of antenna elements is the only means to cover multiple bands, resulting in an increase in the size of mobile terminals.

The above problem will be described in more detail. First, frequencies used for mobile terminals, such as a mobile phone and a smartphone, will be described. FIG. 42 is a table showing a list of frequencies used for mobile terminals. As shown in FIG. 42, three bands of a 800 MHz band, a 1.5 GHz band, and a 2 GHz band are mainly used for mobile terminals in Japan, and three bands of a 700 MHz band, a 900 MHz band, and a 1.9 GHz band are mainly used for mobile terminals in the United States. FIG. 43 show explanatory graphs illustrating the usage of frequencies for mobile terminals in Japan and the United States. FIG. 43(A) shows the usage of frequencies in Japan as indicated by hatched regions. FIG. 43(B) shows the usage of frequencies in the United States as indicated by hatched regions. FIG. 43(C) shows the results of combining the usages of frequencies in both countries.

As shown in FIG. 43(C), the result of combining the frequencies used for mobile terminals in both Japan and the United States shows that the frequencies are classified into four bands. In the following description, a frequency band from 704 to 798 MHz is referred to as a 700 MHz band; a frequency band from 824 to 960 MHz is referred to as a 800 MHz band; a frequency band from 1448 to 1511 MHz is referred to as a 1.5 GHz band; and a frequency band from 1850 to 2170 MHz is referred to as a 2 GHz band.

Since mobile terminals are assumed to be used while roaming in Japan as well as other countries, the mobile terminals need to cover at least the above-mentioned four bands. As means to cover the above-mentioned four bands, the following two means are employed.

A first means is to mount four antennas that respectively cover the bands. However, in reality, it is almost impossible for this means to do this. The reason therefor will be explained below by taking a smartphone as an example.

Recent smartphones have a size of about 130 mm×65 mm×10 mm. The most of the area is occupied by a liquid crystal screen. In general, a metallic plate having the same size as that of the liquid crystal screen is mounted so as to be superimposed on the liquid crystal. When an antenna is mounted near the metallic plate, effective characteristics cannot be obtained. Accordingly, it is necessary to mount the antenna at a distance of about 5 to 10 mm from the metallic plate. Therefore, the region in which the antenna can be mounted is limited to a narrow region with a size of about 10 mm×65 mm×10 mm in upper or lower portions of a mobile terminal.

Antenna element sizes will be considered in the case of a (λ/4)-type inverted L-shaped antenna (λ: wavelength). A size of 107 mm is obtained in the 700 MHz band; a size of 94 mm is obtained in the 800 MHz band; a size of 50 mm is obtained in the 1.5 GHz band; and a size of 38 mm is obtained in the 2 GHz band. It is impossible to mount these four antennas in the above-mentioned narrow region while preventing the antennas from interfering with each other physically and in terms of characteristics.

A second means is a method of adopting a multiband antenna. FIG. 44 is a schematic diagram showing the shape of a two-branch type inverted L-shaped antenna which is generally adopted as a multiband antenna. FIG. 45 is a characteristic diagram showing characteristics of the multiband antenna shown in FIG. 44, and also showing a return loss calculated by using an electromagnetic field simulator. In the upper right portion of FIG. 45, return losses at each boundary frequency of the four bands of the 700 MHz band, the 800 MHz band, the 1.5 GHz band, and the 2 GHz band are shown as numerical values. As a measure of antenna characteristics, an antenna having a return loss of −5 dB or less can be determined to have effective antenna characteristics. Accordingly, the antenna can cover two bands of the 800 MHz band and the 2 GHz band, but it is difficult for the antenna to cover the 700 MHz band and the 1.5 GHz band. Therefore, it is impossible for the antenna to cover all the four bands.

Thus, it is also possible to form the two-branch antenna shape as shown in FIG. 44 into a three-branch antenna shape or a four-branch antenna shape. However, it is difficult to realize such antenna shapes at present, because there are many technical problems, such as an increase in antenna size, or a connection of antenna elements which makes it difficult to obtain desired characteristics.

### Object of the Invention

The present invention has been made in view of the above-mentioned circumstances, and an object of the present invention is to provide a multiband antenna capable of obtaining a plurality of resonances with a simple structure using miniaturized antenna elements and inductors, and operating as a plurality of antennas such as a two-resonance loop antenna, an inverted L-shaped antenna, and an inverted F-shaped antenna, and a mobile terminal.

### Solution to Problem

To solve the problems described above, a multiband antenna and a mobile terminal according to the present invention mainly adopt the following characteristic configurations.

(1) A multiband antenna according to the present invention is a multiband antenna having a plurality of resonance frequencies, the multiband antenna including: a two-resonance loop antenna capable of resonating at two resonance frequencies of a first resonance frequency and a second resonance frequency on a high-frequency side of resonance frequencies, by adding, connecting, and arranging a first inductor and a second inductor to a loop antenna formed of miniaturized antenna elements with an element length shorter than that of each wavelength of the resonance frequencies.

(2) A mobile terminal according to the present invention is mounted with an antenna that covers multiple bands, the antenna being formed by using at least the multiband antenna set forth in the above item (1).

### Advantageous Effects of Invention

The multiband antenna and the mobile terminal according to the present invention provide the following effects.

A first effect is that with the mobile terminal mounted with the multiband antenna, a significant reduction in the size of the device can be achieved. This is because a plurality of resonances can be obtained with an antenna size equivalent to a single-resonance antenna adopted for a general mobile terminal, thereby making it possible to cover multiple bands without increasing the antenna size and the number of antennas.

A second effect is that the cost of the mobile terminal mounted with the multiband antenna can be significantly reduced. This is because the multiband antenna of the present invention can be achieved merely by adding three chip parts (three inductors), or in some cases, four chip parts (three inductors and a capacitor), to the miniaturized antenna elements, in the case of the four-resonance antenna. Thus, a much more inexpensive device can be designed, as compared with the case of adopting an antenna which needs to incorporate an additional antenna element or a complicated configuration.

### BRIEF DESCRIPTION OF DRAWINGS

FIG. 1 is a circuit diagram showing an example of a circuit configuration of a multiband antenna according to the present invention;

FIG. 2 is a schematic diagram showing the shape of the multiband antenna shown in FIG. 1;

FIG. 3 is a schematic diagram schematically showing, as a gray scale, intensities of currents obtained as a result of simulating a distribution of the intensities of the currents in a 1.5 GHz band, prior to the arrangement of a first inductor in a section of a first antenna element;

FIG. 4 is a schematic diagram schematically showing, as a gray scale, intensities of currents obtained by simulating a distribution of the intensities of the currents in the 1.5 GHz band, after the arrangement of the first inductor in the section of the first antenna element and prior to the arrangement of a second inductor in a section of a second antenna element;

FIG. 5 is a schematic diagram schematically showing, as a gray scale, intensities of currents obtained as a result of simulating a distribution of the intensities of the currents in the 1.5 GHz band after the arrangement of the first and second inductors in the respective sections of the first and second antenna elements;

FIG. 6 is a schematic diagram schematically showing, as a gray scale, intensities of currents as a result of simulating a distribution of the intensities of the currents in a 2 GHz band after the arrangement of the first and second inductors in the respective sections of the first and second antenna elements;

FIG. 7 is a connection block diagram for explaining a multiband antenna having a connection configuration in which a third inductor is connected to a power-feed side relative to the second inductor;

FIG. 8 is a schematic diagram schematically showing, as a gray scale, intensities of currents as a result of simulating a distribution of the intensities of the currents in a 700 MHz band of the multiband antenna having the connection configuration shown in FIG. 7;

FIG. 9 is a schematic diagram schematically showing, as a gray scale, intensities of currents as a result of simulating a distribution of the intensities of the currents in a 800 MHz band of the multiband antenna having the connection configuration shown in FIG. 7;

FIG. 10 is a schematic diagram showing a model of a general loop antenna;

FIG. 11 is a schematic diagram showing characteristics of the general loop antenna shown in FIG. 10;

FIG. 12 is a schematic diagram schematically showing, as a gray scale, intensities of currents as a result of simulating a distribution of the intensities of the currents in a 1,700 MHz band of the general loop antenna shown in FIG. 10;

FIG. 13 is a schematic diagram showing an equivalent circuit of the general loop antenna shown in FIG. 10;

FIG. 14 is a schematic diagram showing a model of a miniaturized loop antenna which is miniaturized to a size of 40 mm×20 mm from the size of 68 mm×20 mm of the general loop antenna shown in FIG. 10;

FIG. 15 is a characteristic diagram showing characteristics of the miniaturized loop antenna shown in FIG. 14;

FIG. 16 is a schematic diagram showing a model of a miniaturized loop antenna having a configuration in which another inductor is arranged in the miniaturized loop antenna shown in FIG. 14;

FIG. 17 is a characteristic diagram showing characteristics of the miniaturized loop antenna shown in FIG. 16;

FIG. 18 is a schematic diagram showing a model of a dipole antenna to be compared with the miniaturized loop antenna shown in FIG. 16;

FIG. 19 is a characteristic diagram showing characteristics of the dipole antenna shown in FIG. 18;

FIG. 20 is a comparison table showing a comparison of antenna efficiencies in a 1,760 MHz band among the general loop antenna shown in FIG. 10, the miniaturized loop antenna in which the inductor is arranged as shown in FIG. 16, and the dipole antenna to be compared as shown in FIG. 18;

FIG. 21 is a schematic diagram showing an equivalent circuit of the miniaturized loop antenna model shown in FIG. 16;

FIG. 22 is a schematic diagram schematically showing, as a gray scale, intensities of currents as a result of simulating a distribution of the intensities of the currents in the 1,760 MHz band of the miniaturized loop antenna model shown in FIG. 16;

FIG. 23 is a schematic diagram showing a low-density section in which the current intensity is low in the 1,760 MHz band of the miniaturized loop antenna model shown in FIG. 16;

FIG. 24 is a schematic diagram showing a model of a miniaturized loop antenna having a configuration in which the second inductor is newly arranged in the miniaturized loop antenna shown in FIG. 16;

FIG. 25 is a schematic diagram schematically showing, as a gray scale, intensities of currents as a result of simulating a distribution of the intensities of the currents in the 1,760 MHz band of the miniaturized loop antenna model shown in FIG. 24;

FIG. 26 is a characteristic diagram showing characteristics of the miniaturized loop antenna shown in FIG. 24;

FIG. 27 is a schematic diagram schematically showing, as a gray scale, intensities of currents obtained as a result of simulating a distribution of the intensities of the currents in a 1,960 MHz band of the miniaturized loop antenna shown in FIG. 24;

FIG. 28 is a schematic diagram showing the shape of a model of a general inverted F-shaped antenna;

FIG. 29 is a characteristic diagram showing characteristics of the general inverted F-shaped antenna shown in FIG. 28;

FIG. 30 is a schematic diagram showing the shape of a loop antenna configured by using only a loop portion of the model of the general inverted F-shaped antenna shown in FIG. 28;

FIG. 31 is a characteristic diagram showing characteristics of the loop antenna shown in FIG. 30;

FIG. 32 is a schematic diagram showing a state in which the first inductor is newly arranged in the loop antenna shown in FIG. 30;

FIG. 33 is a characteristic diagram showing characteristics of the loop antenna shown in FIG. 32;

FIG. 34 is a schematic diagram showing a state in which the second inductor is newly arranged in the lop antenna shown in FIG. 32;

FIG. 35 is a characteristic diagram showing characteristics of the loop antenna shown in FIG. 34;

FIG. 36 is a characteristic diagram showing characteristics of the multiband antenna shown in FIG. 2 that has a configuration in which the third inductor, a capacitor, and a fourth antenna element are additionally provided to the loop antenna shown in FIG. 34;

FIG. 37 is a characteristic diagram showing characteristics of the multiband antenna shown in FIG. 2, from which the capacitor is removed;

FIG. 38 is a schematic diagram showing the shape of a two-resonance antenna that covers a 1575.42 MHz band and a 2.4 GHz band;

FIG. 39 is a characteristic diagram showing characteristics of the loop antenna shown in FIG. 38;

FIG. 40 is a characteristic diagram showing results obtained by calculating the antenna efficiency of the loop antenna shown in FIG. 38 by an electromagnetic field simulator;

FIG. 41 is a characteristic diagram showing results obtained by calculating the antenna efficiency of the model of the multiband antenna shown in FIG. 2 by the electromagnetic field simulator;

FIG. 42 is a table showing a list of frequencies used for mobile terminals;

FIG. 43 are explanatory graphs showing the usage of frequencies for mobile terminals in Japan and the United States;

FIG. 44 is a schematic diagram showing the shape of a two-branch type inverted L-shaped antenna that is generally employed as a multiband antenna; and

FIG. 45 is a characteristic diagram showing characteristics of the multiband antenna shown in FIG. 44.

### DESCRIPTION OF EMBODIMENTS

Preferred embodiments of a multiband antenna and a mobile terminal according to the present invention will be described below with reference to the accompanying drawings. The term “mobile terminal” mentioned herein refers to a mobile terminal that incorporates the multiband antenna according to the present invention, and also refers to a miniaturized and portable information terminal, such as a mobile phone, a smartphone, a laptop PC (Personal Computer), or a PDA (Personal Digital Assistants). Any type of frequencies can be used as target frequencies in the present invention, as long as they are frequencies of radio signals to be handled by mobile terminals. Not only frequencies used for mobile phone communication and the like, but also frequencies used for a GPS (Global Positioning System), Bluetooth, wireless LAN (Local Area Network), and the like can be handled in a similar manner.

### Features of the Present Invention

Prior to the description of exemplary embodiments of the present invention, an outline of features of the present invention will now be described. The present invention relates to a multiband antenna which is incorporated in a mobile terminal or the like. The main feature of the present invention is as follows. That is, a plurality of chip parts of inductors (a capacitor may also be included depending on the situation) are mounted in miniaturized antenna elements, which are based on inverted F-shaped antenna elements, and a plurality of, for example, four resonances are generated, thereby achieving a miniaturized antenna that covers multiple bands, without increasing the antenna size. Consequently, a miniaturized antenna which covers multiple bands and can be easily mounted in a mobile terminal can be obtained.

More specifically, taking a multiband antenna, which covers four bands, as an example, in the multiband antenna according to the present invention, at least three inductors are arranged in a miniaturized inverted F-shaped antenna element to generate four resonances, thereby achieving an antenna that covers multiple bands, for example, four bands including a 700 MHz band, a 800 MHz band, a 1.5 GHz band, and a 2 GHz band, without increasing the antenna size.

This is because the multiband antenna according to the present invention includes at least: means for operating as a loop antenna which causes a first inductor to generate a first resonance; means for operating as a loop antenna which causes a second inductor to generate a second resonance while maintaining the first resonant condition; means for allowing an additional antenna element to operate as an inverted F-shaped antenna in a low-frequency band, the additional antenna element being connected through a third inductor having a constant set so as to obtain a high impedance with respect to a loop antenna which operates in a high-frequency band; and means for allowing the additional antenna element connected through the third inductor to operate as an inverted L-shaped antenna in a low-frequency band.

### Configuration Example of Exemplary Embodiment

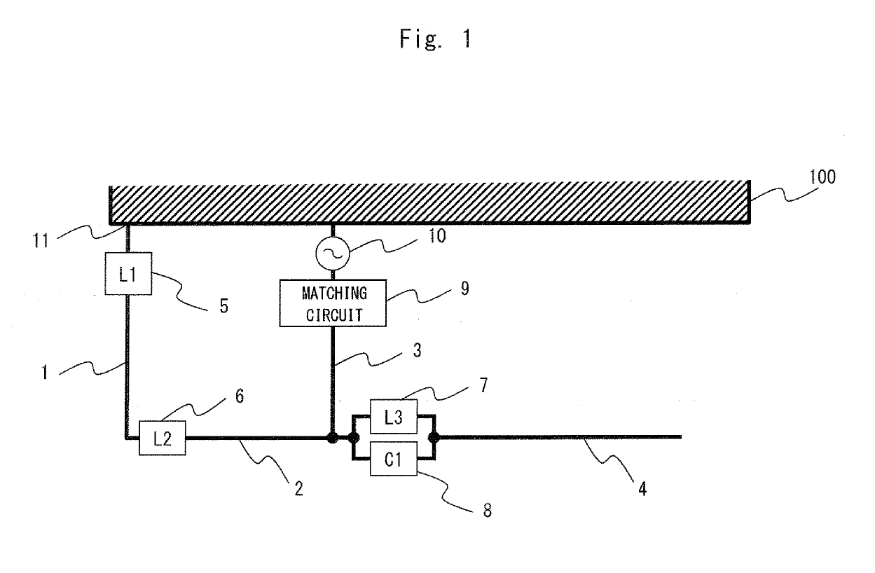

Next, an example of the circuit configuration of the multiband antenna according to the present invention will be described in detail with reference to FIG. 1. FIG. 1 is a circuit diagram showing an example of the circuit configuration of the multiband antenna according to the present invention, and specifically, showing a configuration example of the multiband antenna that covers a plurality of bands, for example, four bands including a 700 MHz band, a 800 MHz band, a 1.5 GHz band, and a 2 GHz band.

The multiband antenna shown in FIG. 1 has a configuration in which three inductors, i.e., first to third inductors 5 to 7 having values of inductances L1 to L3, respectively, are additionally provided and arranged in an inverted F-shaped antenna formed of four miniaturized antenna elements, i.e., first to fourth antenna elements 1 to 4. Referring to FIG. 1, a capacitor 8 having the value of a capacitance C1 is connected in parallel with a third inductor 7. While the capacitor 8 has an effect of facilitating the adjustment of frequencies, the capacitor 8 is not an essential component of the present invention.

In the configuration shown in FIG. 1, the first and third antenna elements 1 and 3 are connected to a GND ground point 11; the first to third antenna elements 1 to 3 form a loop antenna; and the third antenna element 3 is connected with a matching circuit 9 and a power feeding unit 10. The first inductor 5 is arranged at the first antenna element 1, and the second inductor is arranged at the second antenna element 2. A node between the second antenna element 2 and the third antenna element 3 is connected with the fourth antenna element 4 through the third inductor 7. That is, the multiband antenna shown in FIG. 1 has a configuration in which the three inductors, i.e., the first to third inductors 5 to 7 having the values of the inductances L1 to L3, respectively, and the capacitor 8 having the value of the capacitance C1 are arranged in the inverted F-shaped antenna formed of the four antenna elements, i.e., the first to fourth antenna elements 1 to 4, which are grounded at the GND ground point 11, and the power feeding unit 10 feeds electric power to the inverted F-shaped antenna through the matching circuit 9.

Loop antennas generally require an element length of (1λ) (λ: wavelength), while according to the present invention, two resonances can be obtained with a size down to an element length of about (λ/3). This is because, as shown in FIG. 1, the first inductor 5 having the value of the inductance L1 is arranged in a portion which is opposed to the power feeding unit 10 and in which the current intensity is high. This allows the resonance frequency serving as the first resonance to be shifted to a low-frequency band, thereby making it possible to reduce the length of the antenna element. Further, the second inductor 6 having the value of the inductance L2 is arranged in a portion with a low current intensity at a frequency where a resonance is obtained by the first inductor 5 having the value of the inductance L1 as the first resonance, that is, in a portion with a high impedance. This makes it possible to obtain the second resonance without changing the first resonant condition of the first inductor 5 having the value of the inductance L1.

In the multiband antenna according to the present invention, as shown in FIG. 1, the fourth antenna element 4 is also connected to the above-mentioned two-resonance loop antenna through the third inductor 7 having the value of the inductance L3. The third inductor 7 having the value of the inductance L3 selects a predetermined constant as the value of the inductance L3 so as to obtain a high impedance at a high frequency. The high-frequency current flowing through the loop portion functions to prevent a current from flowing into the fourth antenna element 4. As a result, the above-mentioned two-resonance loop antenna resonates in a high-frequency band and the fourth antenna element 4 resonates in a low-frequency band. At this time, the fourth antenna element 4 operates as the inverted F-shaped antenna, which is formed of the four antenna elements, i.e., the first to fourth antenna elements 1 to 4, and also operates as the inverted L-shaped antenna, which is formed of the third and fourth antenna elements 3 and 4, thereby making it possible to generate third and fourth resonances.

Accordingly, by adopting the configuration shown in FIG. 1, an antenna capable of obtaining four resonances can be achieved with the same size as that of the inverted F-shaped antenna that generally obtains only a single resonance. Therefore, the antenna that covers multiple bands can be easily mounted in a mobile terminal, without increasing the size of the mobile terminal.

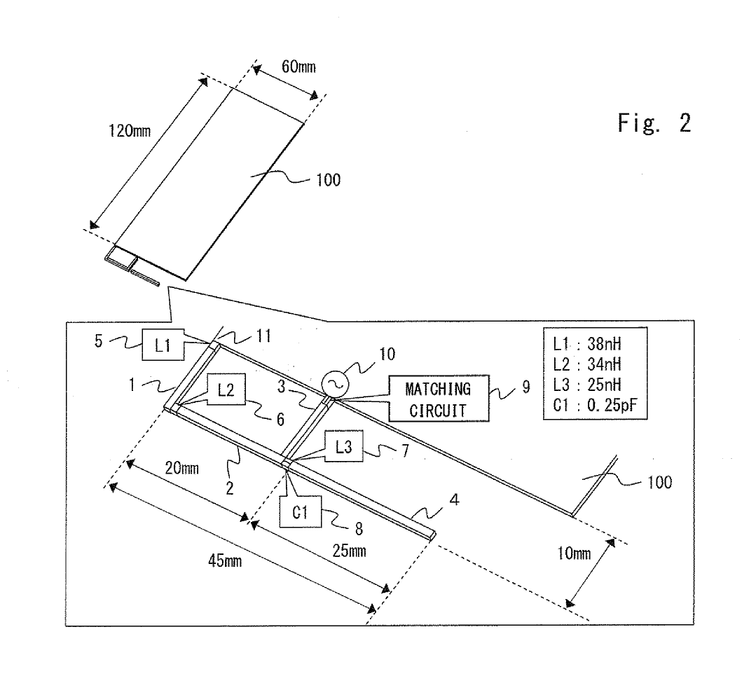

The multiband antenna having the circuit configuration shown in FIG. 1 will be described in further detail with reference to FIG. 2. FIG. 2 is a schematic diagram showing the shape of the multiband antenna shown in FIG. 1. The components shown in FIG. 2 are similar to those of FIG. 1. As the mobile terminal mounted with the multiband antenna, the case where a substrate 100 has a size of 120 mm×60 mm and an antenna region is limited to a region of 10 mm×60 mm will be described by taking a smartphone as an example.

First, three antenna elements, i.e., the first to third antenna elements 1 to 3, are arranged to thereby form the loop antenna that covers two high-frequency bands of the 1.5 GHz band and the 2 GHz band. The formation of a large opening in the loop antenna contributes to the improvement of antenna characteristics, so it is desirable to arrange the power feeding unit 10 and the GND ground point 11 so as to be slightly spaced apart from each other. As described above, the length of the circumference of the loop portion, which is surrounded by the three antenna elements, i.e., the first to third antenna elements 1 to 3, and the substrate 100, may be about (λ/3). Accordingly, in order to cover the two high-frequency bands of the 1.5 GHz band and the 2 GHz band, it is only necessary to secure λ/3=66.6 mm at 1,500 MHz and λ/3=50 mm or more at 2,000 MHz. FIG. 2 shows the case where the length of each of the first and third antenna elements 1 and 3 is set to 10 mm and the length of the second antenna element 2 is set to 20 mm. The length of the circumference of the loop antenna is represented by (10+20)×2=60 mm, which is a length that can cover a region in the vicinity of a high-frequency band approximate to the 1.5 GHz band. The width of each of the antenna elements 1 to 4 is, for example, 1 mm. The inductors 5, 6, and 7, the capacitor 8, and the matching circuit 9 are composed of chip parts. The chip parts of the inductors 5 and 6 have dimensions of, for example, a horizontal width of 1 mm, a vertical width of 0.5 mm, and a thickness of 0.5 mm. The respective chip parts of the inductor 7 and the capacitor 8 have dimensions of, for example, a horizontal width of 0.5 mm, a vertical width of 0.5 mm, and a thickness of 0.5 mm. The matching circuit 9 is formed by, for example, connecting a chip part for an inductor and a chip part for a capacitor in parallel. The chip part for the inductor and the chip part for the capacitor, which constitute the matching circuit 9, each have a horizontal width of 0.5 mm, a vertical width of 0.5 mm, and a thickness of 0.5 mm. The matching circuit 9 can be formed by connecting the chip part for the inductor and the chip part for the capacitor in parallel as described above, or can be formed of a single chip part obtained by molding an electric circuit composed of an inductor and a capacitor.

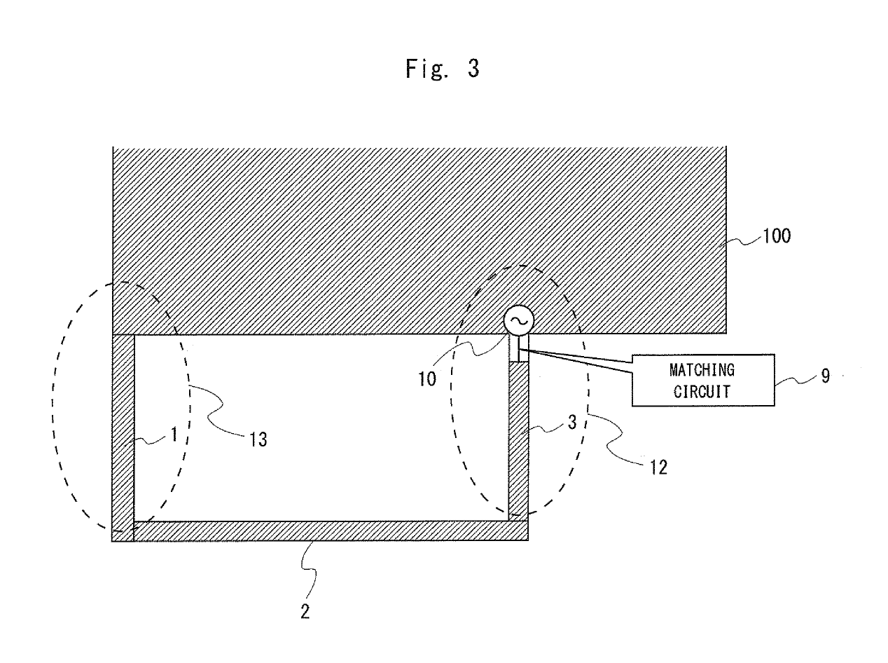

Next, the inductor 5 having the value of the inductance L1 is arranged so as to allow the loop antenna, which is formed of the three antenna elements, i.e., the first to third antenna elements 1 to 3, to resonate in the 1.5 GHz band. Loop antennas generally have two sections in which the current becomes a maximum, that is, the section in the vicinity of the power feeding unit 10 and the section opposed to the power feeding unit 10 (the section on the side of the first antenna element 1). The inductor 5 having the value of the inductance L1 is arranged in the section which is opposed to the power feeding unit 10 and in which the current intensity is high. FIG. 3 is a schematic diagram schematically showing, as a gray scale, intensities of currents as a result of simulating a distribution of the intensities of the currents in the 1.5 GHz band, prior to the arrangement of the first inductor 5 having the value of the inductance L1 in the section of the first antenna element 1. In FIG. 3, a section in which the current intensity is high is displayed at a high density (black), and a section in which the current intensity is low is displayed at a low density (white). The term “a section in which the current intensity is high” used herein refers to a section in which a resonance is obtained at a frequency of the 1.5 GHz band.

As shown in FIG. 3, it is apparent that a high-density section 13, in which the current intensity is high, is present on the first antenna element 1 that is opposed to the power feeding unit 10. The reason why the current intensity is not high in a power-feed peripheral portion 12 of the third antenna element 3, in which the power feeding unit 10 is arranged, is that a resonance is not obtained in the 1.5 GHz band in the state where the first inductor 5 having the value of the inductance L1 is not arranged. While the first inductor 5 having the value of the inductance L1 is arranged in the high-density section 13 in which the current intensity is high, the resonance frequency varies depending on the arrangement position. Accordingly, the arrangement position may be slightly adjusted so as to obtain a desired resonance frequency.

While in this exemplary embodiment, the constant of the inductance L1 of the first inductor 5 is set to 38 nH, it is also possible to select a constant in a range of about 10 nH to 60 nH so as to adjust the resonance frequency in the 1.5 GHz band.

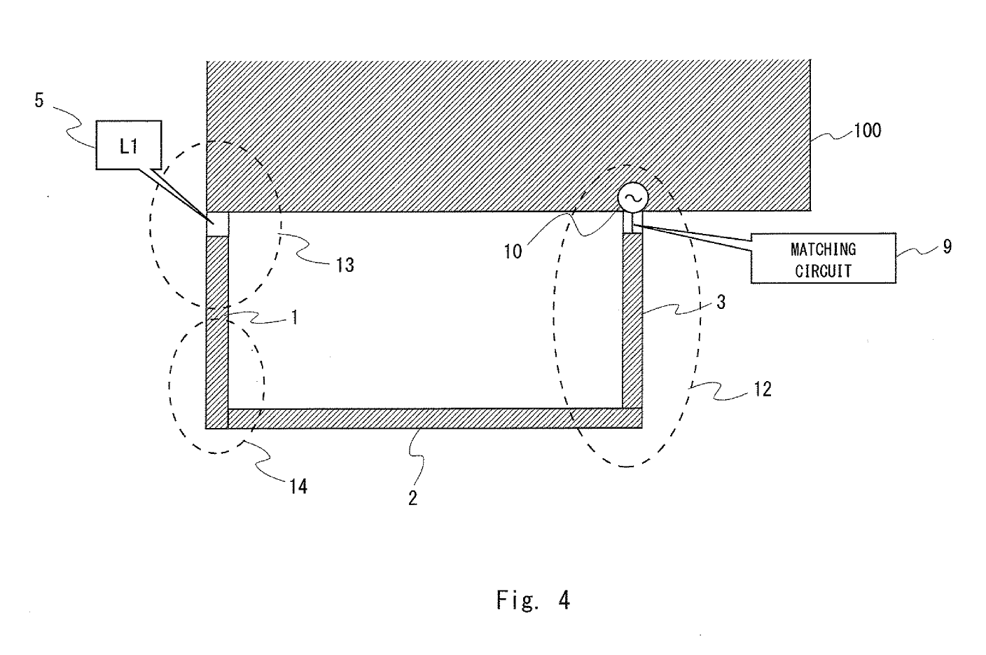

Next, the second inductor 6 having the value of the inductance L2 is arranged in the section of the second antenna element 2. FIG. 4 is a schematic diagram schematically showing, as a gray scale, intensities of currents as a result of simulating a distribution of the intensities of the currents in the 1.5 GHz band, after the arrangement of the first inductor 5 having the value of the inductance L1 in the section of the first antenna element 1 and prior to the arrangement of the second inductor 6 having the value of the inductance L2 in the section of the second antenna element 2. In the state where the first inductor 5 having the value of the inductance L1 is arranged in the section of the first antenna element 1, a resonance is obtained in the 1.5 GHz band. Accordingly, as shown in FIG. 4, it is apparent that the antenna has two sections in which the current intensity is high, that is, the power-feed peripheral portion 12 and the high-density section 13 that is opposed to the power feeding unit 10.

In this case, in order to obtain a resonance in the 2 GHz band, the second inductor 6 having the value of the inductance L2 is arranged in a low-density section 14 in which the current intensity is low in the 1.5 GHz as shown in FIG. 4, to thereby prevent the resonant condition in the 1.5 GHz band from being changed.

In this exemplary embodiment, the constant of the inductance L2 of the second inductor 6 is set to 34 nH. However, it is also possible to select a constant in the range of about 10 nH to 60 nH so as to adjust the resonance frequency in the 2 GHz band, as in the case of the inductance L1 of the first inductor 5.

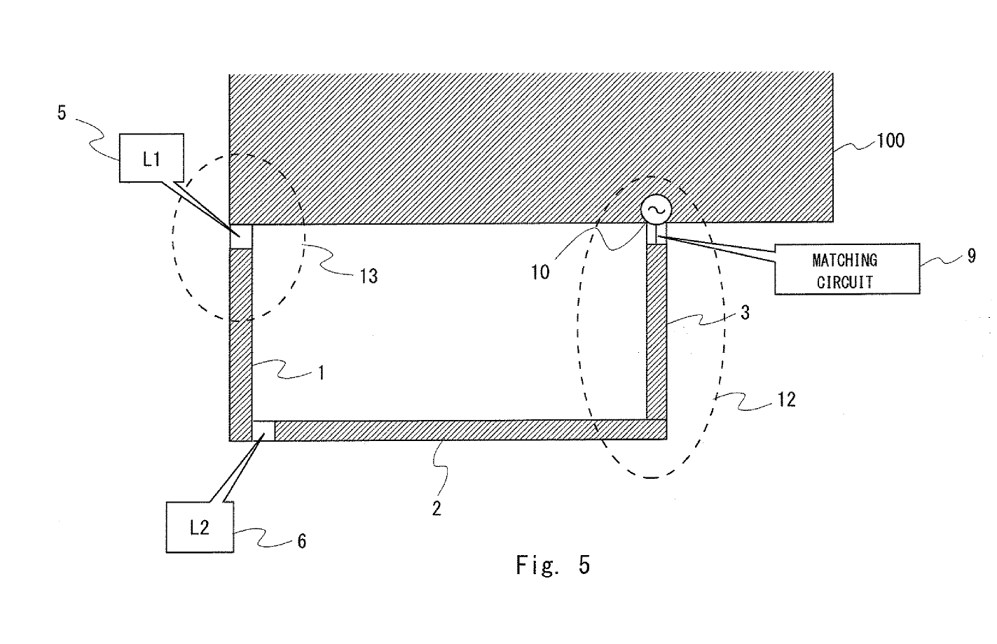

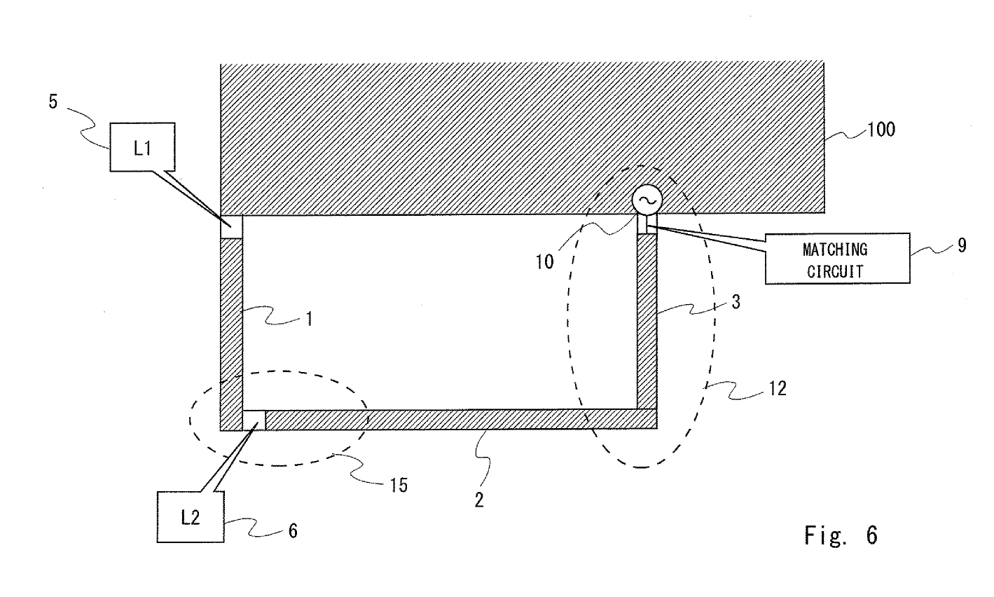

FIGS. 5 and 6 show the results of simulating a distribution of currents in the configuration in which the first and second inductors 5 and 6 are arranged as described above. Specifically, FIG. 5 is a schematic diagram schematically showing, as a gray scale, intensities of currents as a result of simulating a distribution of the intensities of the currents in the 1.5 GHz band, after the arrangement of the first and second inductors 5 and 6 having the values of the inductances L1 and L2, respectively, in the respective sections of the first and second antenna elements 1 and 2. FIG. 6 is a schematic diagram schematically showing, as a gray scale, intensities of currents as a result of simulating a distribution of the intensities of the currents in the 2 GHz band, after the arrangement of the first and second inductors 5 and 6 having the values of the inductances L1 and L2, respectively, in the respective sections of the first and second antenna elements 1 and 2.

As shown in the current distribution of FIG. 5, in the 1.5 GHz band, the current intensity is high in the two sections of the power-feed peripheral portion 12 and the high-density section 13 in which the first inductor 5 having the value of the inductance L1 is arranged. Further, as shown in the current distribution of FIG. 6, in the 2 GHz band, the current intensity is high in the two sections of the power-feed peripheral portion 12 and a high-density section 15 in which the second inductor 6 having the value of the inductance L2 is arranged. Accordingly, it is apparent that the two-resonance loop antenna that resonates in the two bands of the 1.5 GHz band and the 2 GHz band is achieved by a single loop antenna.

Furthermore, in the multiband antenna of this exemplary embodiment, as shown in FIG. 2, the fourth antenna element 4 is additionally provided and arranged, as an additional antenna element, through the third inductor 7 having the value of the inductance L3 in the loop antenna formed of the first to third antenna elements 1 to 3.

In the third inductor 7 having the value of the inductance L3, the predetermined constant is set so as to obtain a high impedance at a high frequency of 1.5 GHz or more, as an inductance value, to thereby prevent the operation of the loop antenna from being changed. While the constant of the inductance L3 of the third inductor 7 is set to 25 nH in this exemplary embodiment, it is desirable to select a constant in a range of at least 20 nH or more so as to obtain a sufficiently high impedance in a high-frequency band equal to or higher than the 1.5 GHz band.

As for the position where the third inductor 7 having the value of the inductance L3 is connected to the loop antenna, one end of the third inductor 7 is connected at the position of a node between the second antenna element 2 in which the second inductor 6 is arranged and the third antenna element 3 in which the power feeding unit 10 is arranged, thereby connecting the third inductor 7 to the power-feed side relative to the second inductor 6 having the value of the inductance L2.

The third inductor 7 is connected to the power-feed side of the second inductor 6 as described above for the following two reasons. The first reason is that in the state where the first inductor 5 having the value of the inductance L1 and the second inductor 6 having the value of the inductance L2 are interposed between the connected position of the third inductor 7 and the power feeding unit 10, the first inductor 5 having the value of the inductance L1 and the second inductor 6 having the value of the inductance L2 serve as the matching circuit of the fourth antenna element 4, which causes a deviation of the impedance in the 700 MHz band and 800 MHz band used by the fourth antenna element 4.

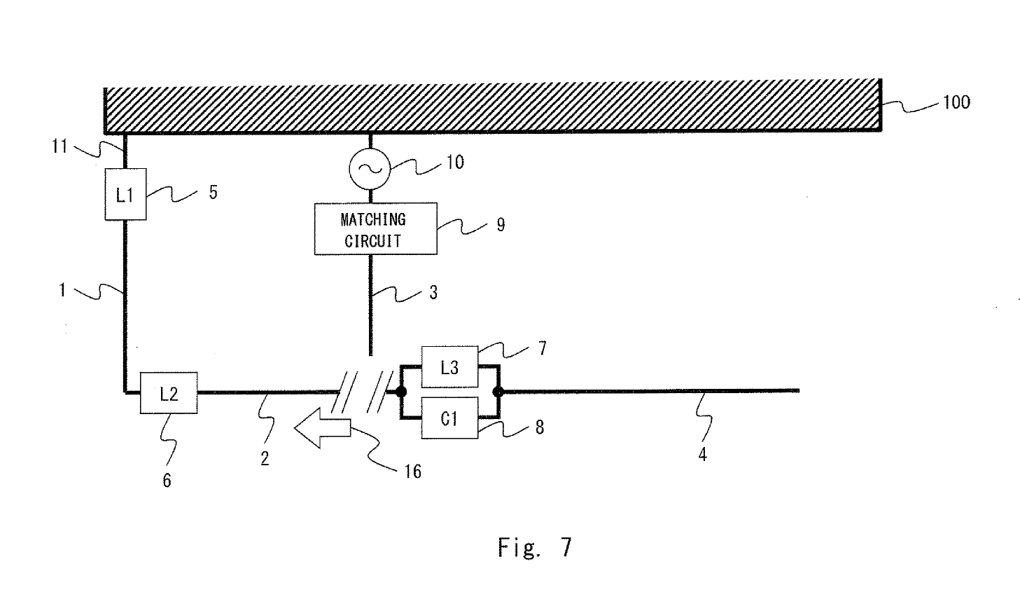

The second reason is that the third inductor 7 having the value of the inductance L3 is connected to the power-feed side relative to the first inductor 5 having the value of the inductance L1 and the second inductor 6 having the value of the inductance L2, thereby setting a impedance 16 obtained when the GND ground point 11 side is observed from the connected position indicated by the arrow in FIG. 7 to be high in the frequency band of 800 MHz. Ideally, the impedance 16 is infinite in the vicinity of 960 MHz and the connection indicated by the arrow in FIG. 7 is in an open state. FIG. 7 is a connection block diagram for explaining the multiband antenna having a connection configuration in which the third inductor 7 having the value of the inductance L3 is connected to the power-feed side relative to the second inductor 6.

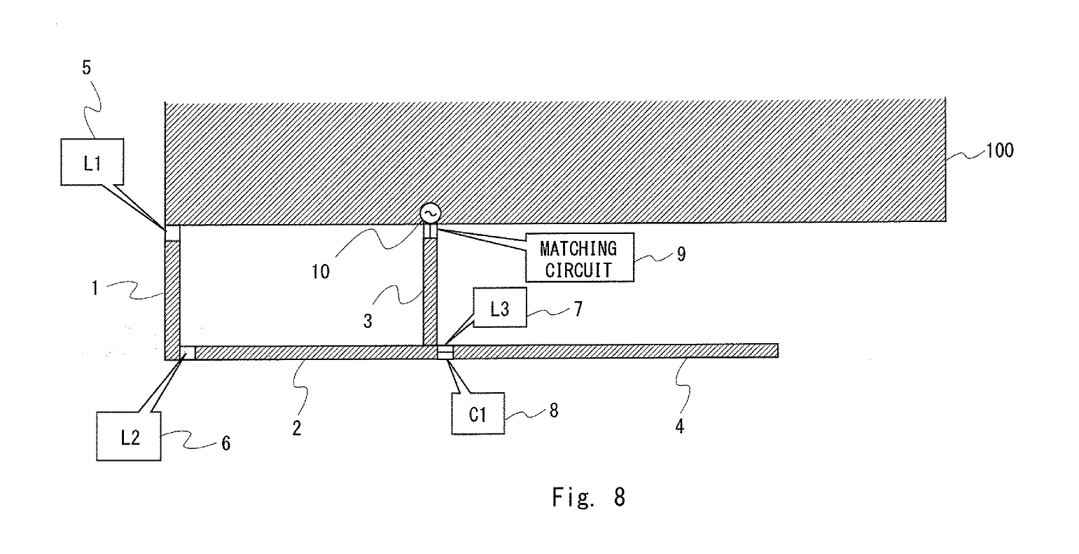

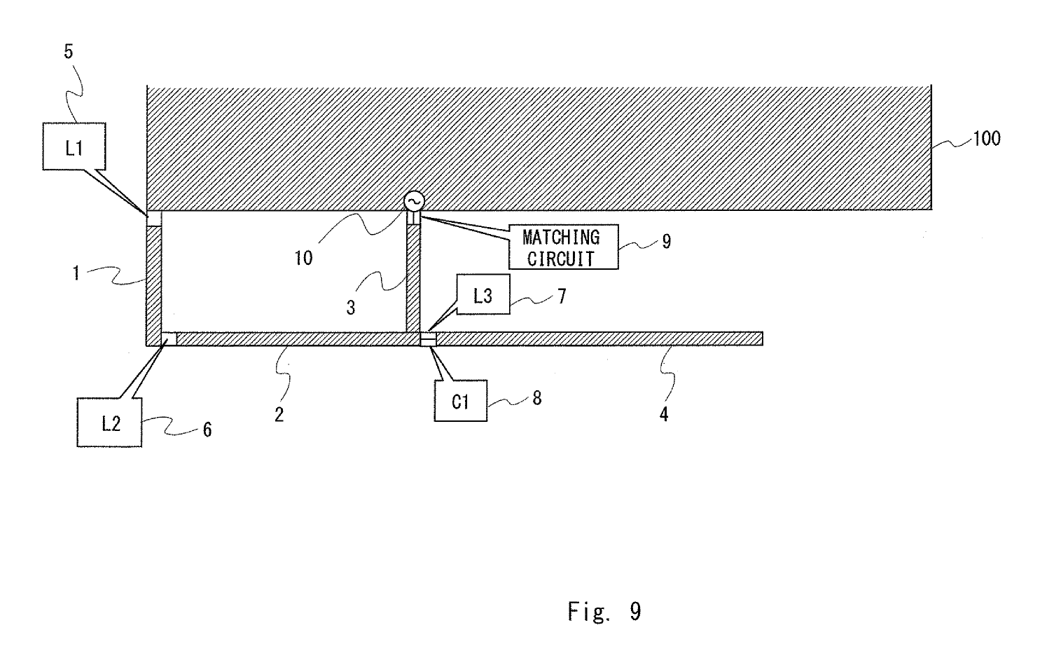

With the connection configuration shown in FIG. 7, in the 700 MHz band, the antenna operates as the inverted F-shaped antenna formed of the first to fourth antenna elements 1 to 4, and also operates as the inverted L-shaped antenna formed of the third and fourth antenna elements 3 and 4. These operations are apparent also from the fact that a current flows through all of the first to fourth antenna elements 1 to 4 as shown in the current distribution in the 700 MHz band shown in FIG. 8, whereas as shown in the current distribution in the 800 MHz band shown in FIG. 9, the current hardly flows through the first and second antenna elements 1 and 2 and basically only flows through the third and fourth antenna elements 3 and 4. In this regard, FIG. 8 is a schematic diagram schematically showing, as a gray scale, intensities of currents as a result of simulating a distribution of the intensities of the currents in the 700 MHz band of the multiband antenna having the connection configuration shown in FIG. 7. FIG. 9 is a schematic diagram schematically showing, as a gray scale, intensities of currents as a result of simulating a distribution of the intensities of the currents in the 800 MHz band of the multiband antenna having the connection configuration shown in FIG. 7.

This exemplary embodiment illustrates, as shown in FIGS. 2 and 7, a configuration example in which the capacitor 8 having the value of the capacitance C1 is arranged in parallel with the third inductor 7 having the value of the inductance L3. However, the capacitor 8 having the value of the capacitance C1 is arranged so as to facilitate the adjustment of the balance between the 800 MHz band and the 1.5 GHz band, and is not an essential component in the multiband antenna according to the present invention. The capacitor 8 having the value of the capacitance C1 is not necessarily provided as long as the frequency adjustment as described above can be made.

### (Description of Operation in Exemplary Embodiment)

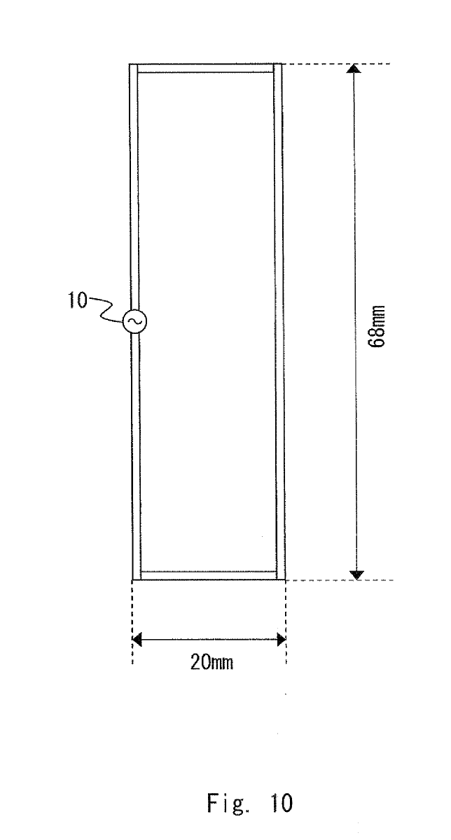

Next, an operation of the multiband antenna shown in FIG. 1 as an example of the present invention will be described in detail with reference to the drawings. First, the operation principle of the present invention will be described step by step with reference to a model of a basic loop antenna shown in FIG. 10.

FIG. 10 is a schematic diagram showing a model of a general loop antenna. The loop antenna shown in FIG. 10 has a size of 68 mm×20 mm and an antenna element circumference of (68+20)×2=176 mm. Since the loop antenna resonates at the length of (1λ) (λ: wavelength), the antenna having an antenna element length of 176 mm resonates at 1,700 MHz according to calculations. Further, since the loop antenna resonates at frequencies of 1λ, 2λ, 3λ, . . . , the antenna having a size in which a resonance is obtained at 1,700 MHz generates resonances at 1,700 MHz, 3,400 MHz, 5,100 MHz, . . . , respectively. Accordingly, it is difficult for the general loop antenna to generate two resonances in two frequency bands close to each other, such as the 1.5 GHz band and the 2 GHz band.

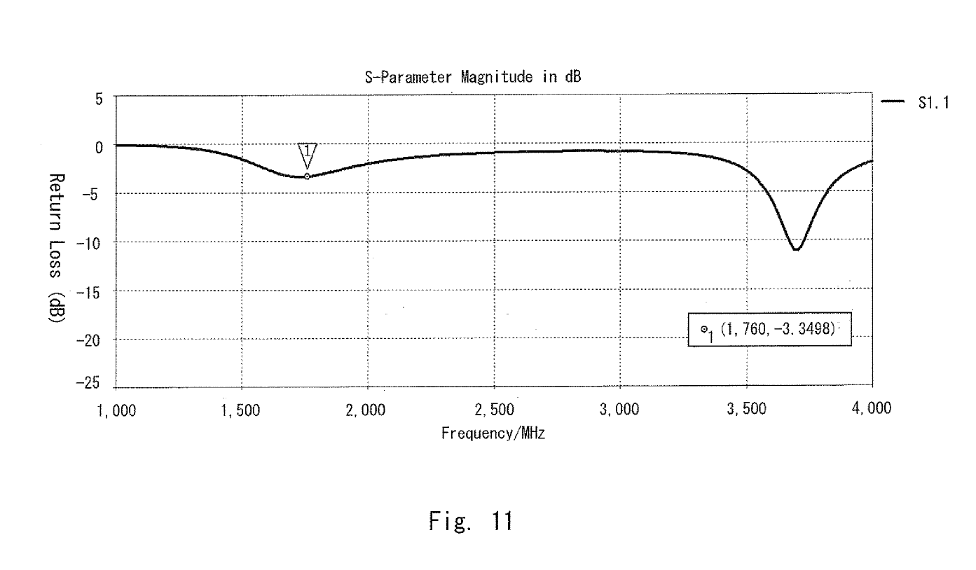

FIG. 11 shows the results obtained by calculating a return loss for the model of the general loop antenna shown in FIG. 10 by an electromagnetic field simulator. In other words, FIG. 11 is a characteristic diagram showing the characteristics of the general loop antenna shown in FIG. 10, where the horizontal axis represents a frequency and the vertical axis represents a return loss. In FIG. 11, a point where the return loss decreases corresponds to a resonance point.

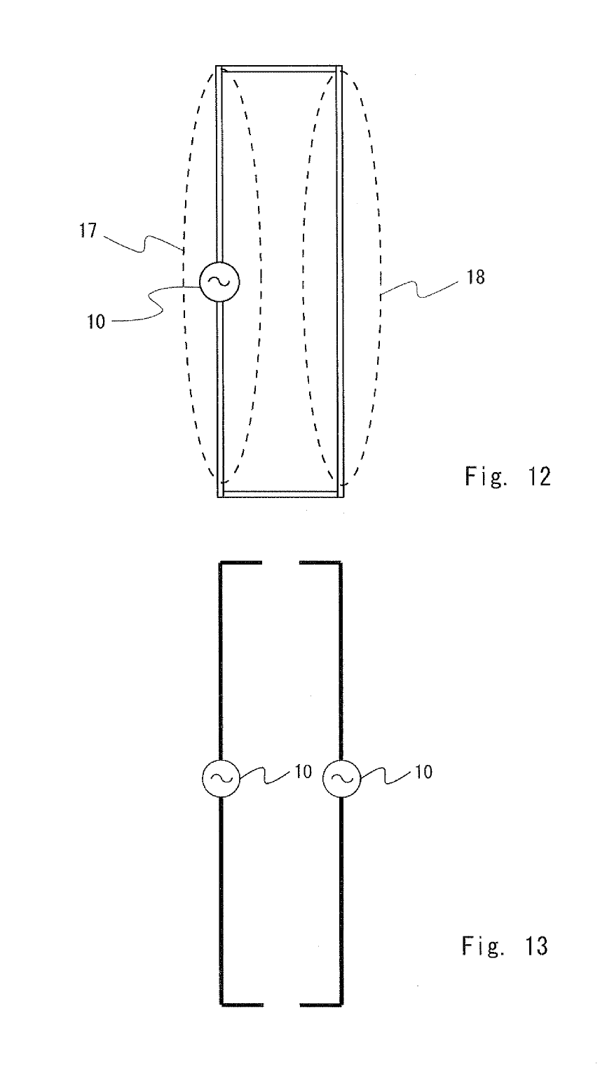

As shown in the lower right portion of FIG. 11, the resonance point at which the frequency is lowest in the model of the loop antenna shown in FIG. 10 is 1,760 MHz, as indicated by a marker 1 on the graph of FIG. 11, and it is obvious that the resonance point substantially matches 1,700 MHz, which is the calculated value of the resonance frequency described above. In the current distribution at 1,760 MHz of the loop antenna shown in FIG. 10, the current intensity is high at two sections of a power-feed peripheral section 17 in the vicinity of the power feeding unit 10 and a high-density section 18 that is opposed to the power feeding unit 10 as shown in FIG. 12. FIG. 12 is a schematic diagram schematically showing, as a gray scale, intensities of currents as a result of simulating a distribution of the intensities of the currents in the 1,700 MHz band of the general loop antenna shown in FIG. 10.

In this manner, in the model of the loop antenna shown in FIG. 10, the state where the current intensity is high in the two sections of the power-feed peripheral section 17 in the vicinity of the power feeding unit 10 and the high-density section 18 that is opposed to the power feeding unit 10 indicates the resonant condition of the loop antenna. FIG. 13 is a schematic diagram showing an equivalent circuit representing the resonant condition. The loop antenna is equivalent to a configuration in which two dipole antennas are arranged. FIG. 13 is a schematic diagram showing an equivalent circuit of the general loop antenna shown in FIG. 10, and also showing that the loop antenna in the resonant condition is equivalent to the antenna configuration in which two dipole antennas are arranged in parallel.

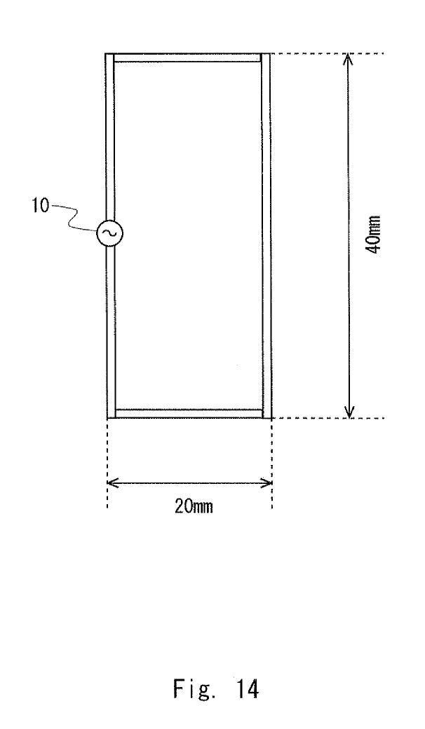

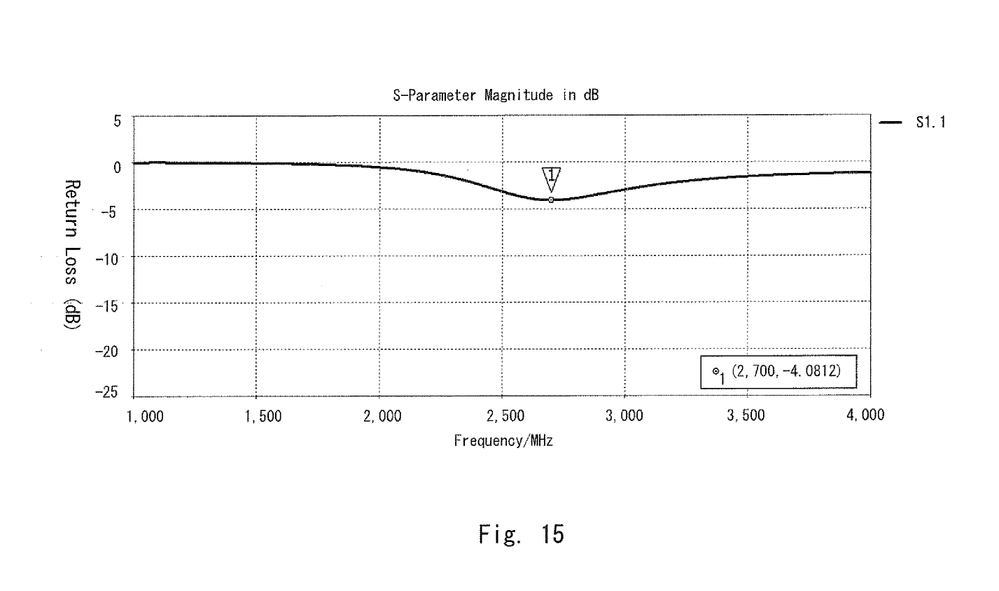

As described above, the general loop antenna shown in FIG. 10 requires the wavelength of (1λ), at which a resonance frequency is obtained, as the length of the circumference of the antenna element, which causes a problem of an increase in the size thereof. Further miniaturization is required for the antenna to be incorporated in a miniaturized mobile terminal. Accordingly, in order to achieve the miniaturization of the loop antenna to a size which allows the antenna to be incorporated in the mobile terminal, the size of the antenna element on the long side of the general loop antenna shown in FIG. 10 is reduced, for example, from 68 mm to 40 mm as shown in FIG. 14.

FIG. 14 is a schematic diagram showing a model of a miniaturized loop antenna which is reduced in size to 40 mm×20 mm from 68 mm×20 mm of the general loop antenna shown in FIG. 10. In the case of the miniaturized loop antenna shown in FIG. 14, the length of the circumference of the antenna element is reduced to (40+20)×2=120 mm from (68+20)×2=176 mm shown in FIG. 10.

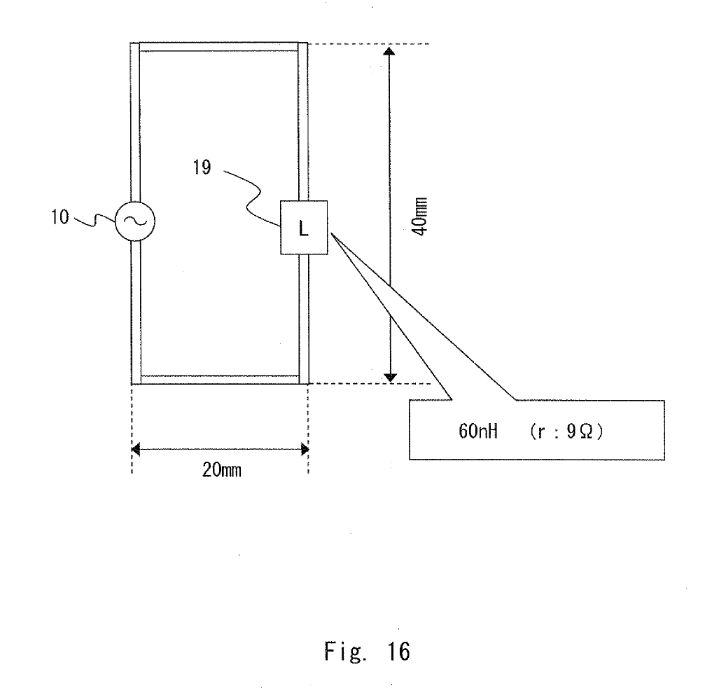

As a result, in the miniaturized loop antenna shown in FIG. 14, as indicated by the marker 1 on the graph of FIG. 15, the reduction in size from the loop antenna shown in FIG. 10 causes an increase in the resonance frequency from 1,700 MHz to 2,700 MHz. FIG. 15 is a characteristic diagram showing the characteristics of the miniaturized loop antenna shown in FIG. 14, where the horizontal axis represents a frequency and the vertical axis represents a return loss. In FIG. 15, a point where the return loss decreases corresponds to a resonance point.

According to the present invention, as shown in FIG. 16, an inductor 19 is newly arranged in the high-density section, which is opposed to the power feeding unit 10 and in which the current intensity is high in the miniaturized loop antenna shown in FIG. 14, so that a resonance frequency equivalent to that in the case of the loop antenna shown in FIG. 10 can also be obtained in the miniaturized loop antenna shown in FIG. 14. In this case, as the constants of the inductor 19, the inductance is set to 60 nH and the internal resistance is set to 9Ω. FIG. 16 is a schematic diagram showing a model of a miniaturized loop antenna having a configuration in which the inductor 19 is newly arranged in the miniaturized loop antenna shown in FIG. 14.

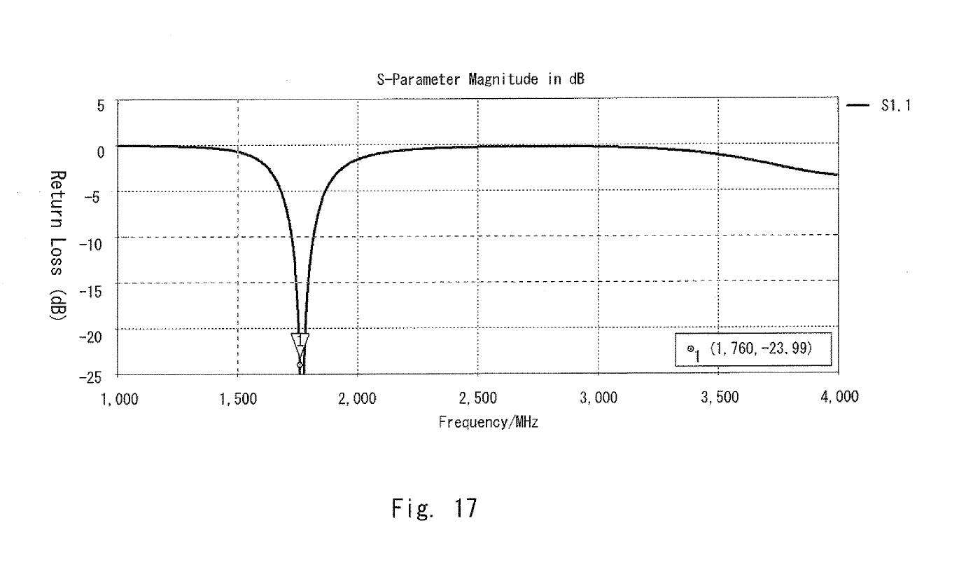

The model of the miniaturized loop antenna shown in FIG. 16 has a resonance frequency of about 1,760 MHz as indicated by the marker 1 on the graph of FIG. 17. Thus, the resonance frequency equivalent to that of the general loop antenna of 68×20 mm shown in FIG. 10 can be obtained. FIG. 17 is a characteristic diagram showing the characteristics of the miniaturized loop antenna shown in FIG. 16, where the horizontal axis represents a frequency and the vertical axis represents a return loss.

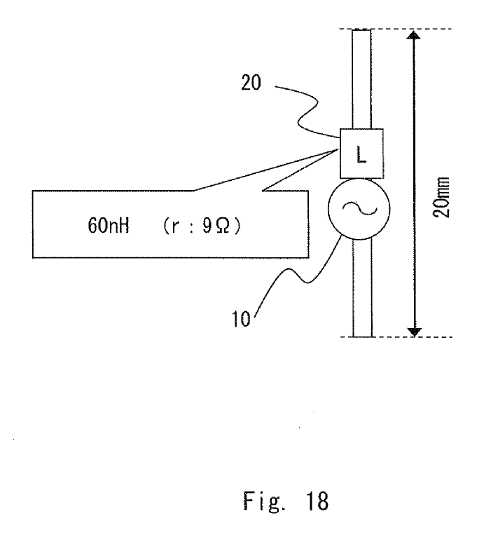

Next, the deterioration in antenna efficiency due to the presence of the internal resistance 9Ω of the inductor 19 in the miniaturized loop antenna shown in FIG. 16 will now be considered. In general, when a resistance component as large as 9Ω is present in the antenna element, a large loss in terms of antenna characteristics is generated, which can cause the deterioration in antenna efficiency. Accordingly, the characteristics of the miniaturized loop antenna are compared with the characteristics of a dipole antenna as shown in FIG. 18.

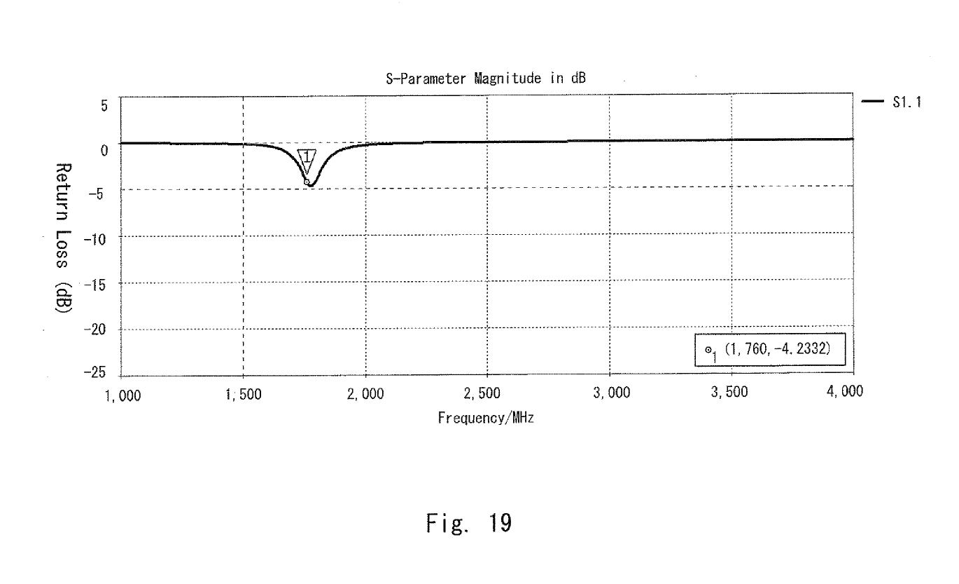

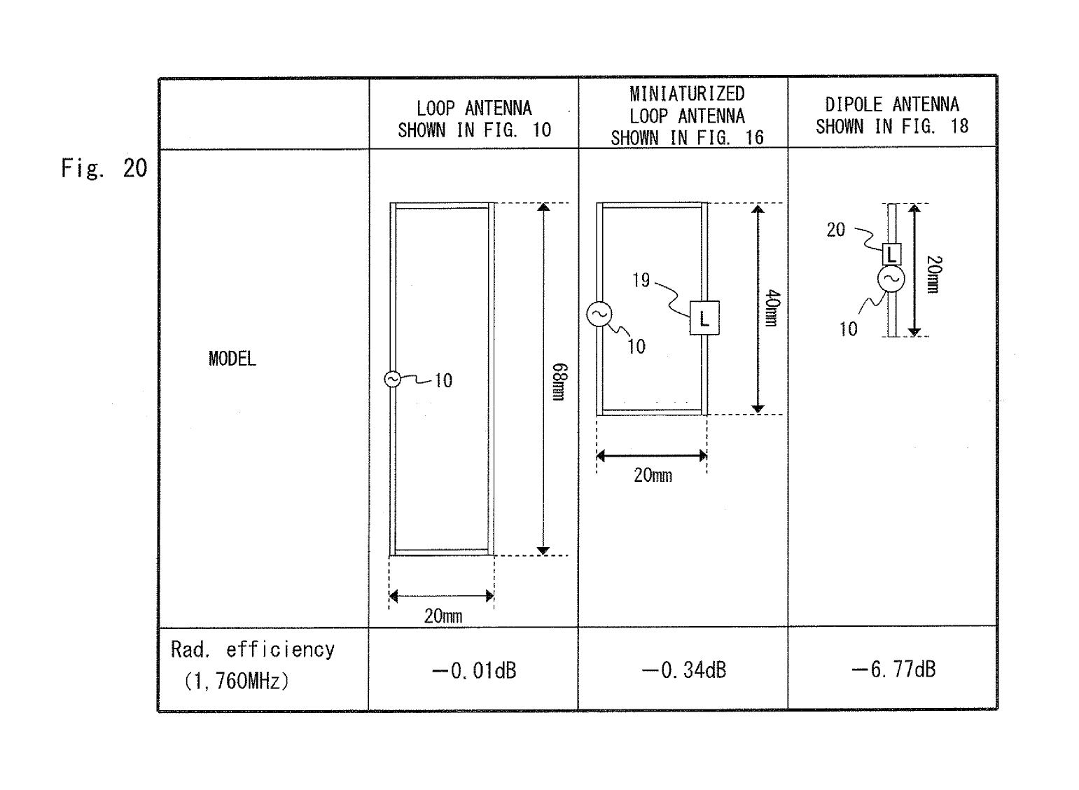

FIG. 18 is a schematic diagram showing a model of a dipole antenna to be compared with the miniaturized loop antenna shown in FIG. 16, and also showing the case where an inductor 20 having constants similar to those of the case of FIG. 16 is arranged in the dipole antenna. Specifically, the constants of the inductor 20 are set to the same values (an inductance of 60 nH, an internal resistance of 9Ω) as those of the inductor 19 in the miniaturized loop antenna shown in FIG. 16. In addition, the length of each antenna element is adjusted, and the resonance frequency is adjusted, as indicated by the marker 1 on the graph of FIG. 19, to 1,760 MHz, as in the case of the miniaturized loop antenna shown in FIG. 16. FIG. 19 is a characteristic diagram showing the characteristics of the dipole antenna shown in FIG. 18, where the horizontal axis represents a frequency and the vertical axis represents a return loss.

FIG. 20 shows the results of the comparison among the antenna efficiencies at 1,760 MHz of the general loop antenna shown in FIG. 10, the miniaturized loop antenna in which the inductor 19 is arranged as shown in FIG. 16, and the dipole antenna to be compared as shown in FIG. 18. In other words, FIG. 20 is a comparison table showing a comparison of the antenna efficiencies at 1,760 MHz among the general loop antenna shown in FIG. 10, the miniaturized loop antenna in which the inductor 19 is arranged as shown in FIG. 16, and the dipole antenna to be compared as shown in FIG. 18.

As shown in the field of the antenna efficiency (Rad. Efficiency) at 1,760 MHz in FIG. 20, the loop antenna of 68×20 mm in FIG. 10 shows a satisfactory antenna efficiency value of −0.01 dB. The term “Rad. Efficiency (Radiation Efficiency)” representing an antenna efficiency refers to a value used to compare only the antenna efficiencies after a matching loss generated between a feeding point and an antenna impedance is corrected.

Further, in the dipole antenna to be compared as shown in FIG. 18, the antenna efficiency is significantly lowered to −6.77 dB as shown in the right field of the table of FIG. 20. Such a deterioration is mostly due to a loss caused by the internal resistance 9Ω of the inductor 20. On the other hand, in the miniaturized loop antenna in which the inductor 19 is arranged as shown in FIG. 16, the antenna efficiency shows a satisfactory value of −0.34 dB as shown in the central field of the table of FIG. 20, even though the inductor 19 having the internal resistance 9Ω is arranged in the antenna.

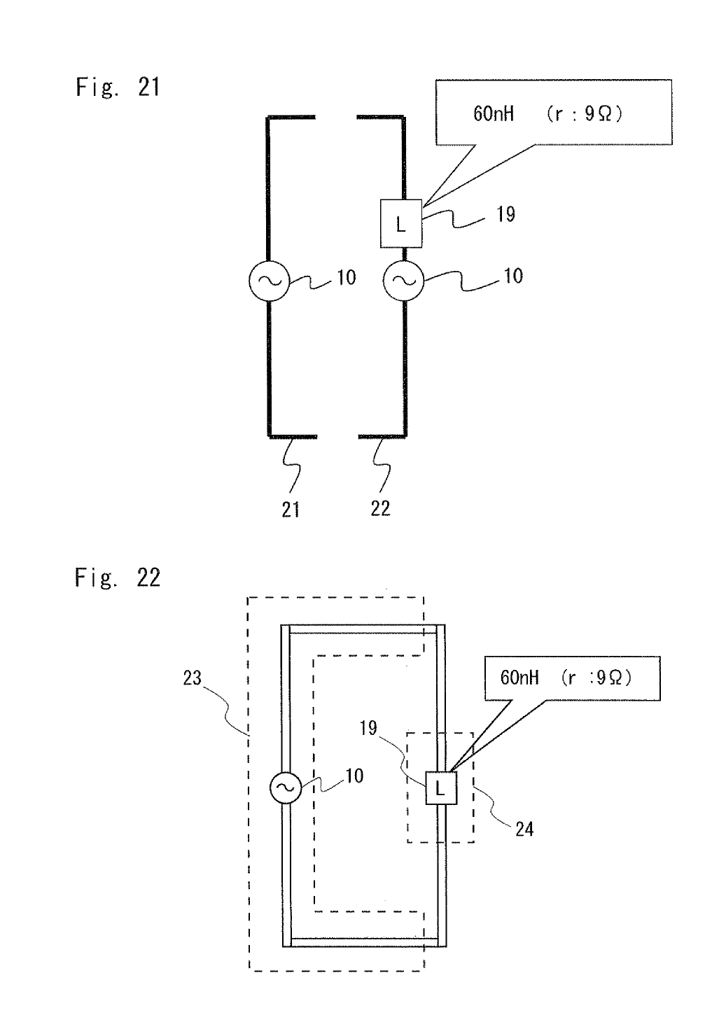

The reason why the miniaturized loop antenna, in which the inductor 19 is arranged as shown in FIG. 16, is a model corresponding to the loop antenna according to the exemplary embodiment of the present invention described above with reference to FIGS. 1 and 2 and why the antenna efficiency thereof shows a satisfactory value of −0.34 dB regardless of the fact that the inductor 19 having an internal resistance of 9Ω is arranged in the antenna will be described with reference to FIG. 21. FIG. 21 is a schematic diagram showing an equivalent circuit of the miniaturized loop antenna model shown in FIG. 16. As in the case shown in the equivalent circuit of FIG. 13, the miniaturized loop antenna in the resonant condition is equivalent to the antenna configuration in which the two dipole antennas, i.e., the first and second dipole antennas 21 and 22, are arranged in parallel.

In the equivalent circuit shown in FIG. 21, a second dipole antenna 22 has a configuration similar to that in the case of the dipole antenna of FIG. 18 as shown in the comparison table of FIG. 20. The antenna efficiency is significantly lowered due to the internal resistance of the inductor 19. On the other hand, the antenna efficiency of a first dipole antenna 21 is not lowered because the first dipole antenna 21 includes no resistance component. The term “efficiency” of the loop antenna refers to how much the fed electric power is emitted from each antenna element. For example, when the first dipole antenna 21 and the second dipole antenna have equivalent characteristics and are in a satisfactory condition, the fed electric power is evenly distributed to the first dipole antenna 21 and the second dipole antenna, and is evenly emitted therefrom.

On the other hand, as in this exemplary embodiment illustrating the equivalent circuit of FIG. 21, when the antenna characteristics of the second dipole antenna 22 significantly deteriorate, most of the electric power fed to the antenna is supplied and emitted to the first dipole antenna 21 that shows satisfactory characteristics. Accordingly, even when the characteristics of the second dipole antenna 22 significantly deteriorate, the fed electric power is emitted from the first dipole antenna 21 without fail, so that the loop antenna characteristics of the miniaturized loop antenna as shown in FIG. 16, in which the inductor 19 having an internal resistance is arranged, do not deteriorate. For the reason described above, the miniaturization of the loop antenna can be achieved without deteriorating the antenna characteristics.

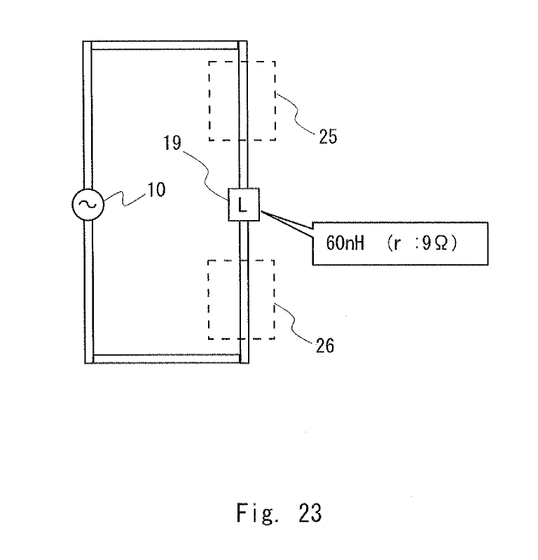

Next, means for obtaining two resonances as the miniaturized loop antenna will be described. As described above, the model of the miniaturized loop antenna in which the inductor 19 is arranged as shown in FIG. 16 resonates at a frequency of 1,760 MHz as shown in the characteristic diagram of FIG. 17. As shown in the schematic diagram of FIG. 22, in a current distribution obtained when the antenna resonates at a frequency of 1,760 MHz, a power-feed peripheral section 23, which is in the vicinity of the power feeding unit 10 and in which the current intensity is high, extends over a wide range, and a high-density section 24, which is opposed to the power feeding unit 10 and in which the current intensity is high, extends over a narrow range as a result of the effect that the inductor 19 is shortened. FIG. 22 is a schematic diagram schematically showing, as a gray scale, intensities of currents as a result of simulating a distribution of the intensities of the currents in the 1,760 MHz band of the miniaturized loop antenna model shown in FIG. 16.

The low-density section which is present in the vicinity of the high-density section 24 shown in FIG. 22 and in which the current intensity is low at 1,760 MHz will now be focused on. FIG. 23 is a schematic diagram showing low-density sections in which the current intensity is low in the 1,760 MHz band of the miniaturized loop antenna model shown in FIG. 16, and also showing the sections that are extracted as the low-density sections based on the results of the simulation of the current distribution shown in FIG. 22.

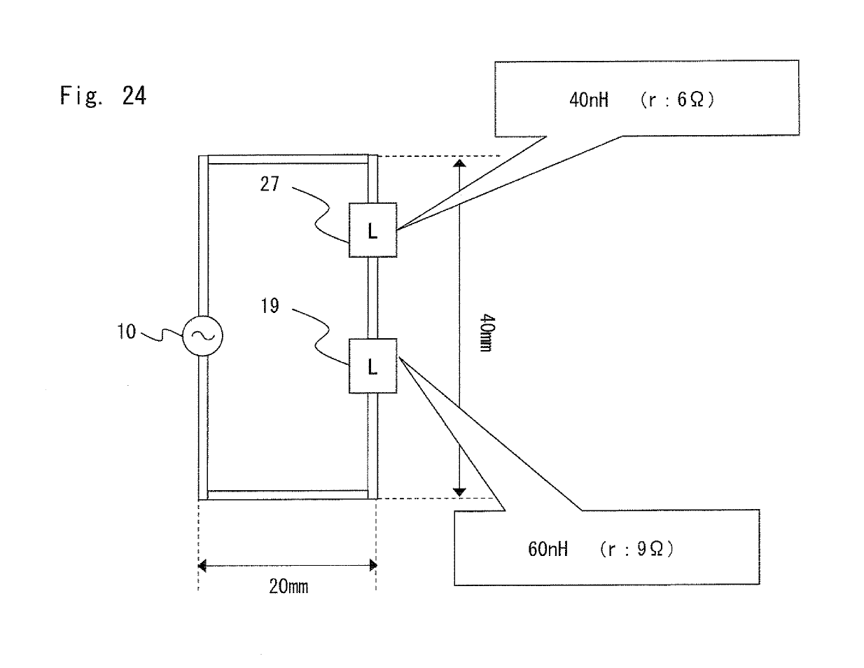

As shown in FIG. 23, there are two low-density sections, i.e., first and second low-density sections 25 and 26, in which the current intensity is low in the 1,760 MHz band. In order to obtain a second resonance frequency without causing any adverse effect on the resonance operation at 1,760 MHz, a second inductor 27, which is different from the inductor 19 (the inductor corresponding to the first inductor), is newly arranged as shown in FIG. 24 in one of the first and second low-density sections 25 and 26, which are opposed to the power feeding unit 10 and in which the current intensity is low, in the miniaturized loop antenna shown in FIG. 23. In this case, as the constants of the second inductor 27, the inductance is set to 40 nH and the internal resistance is set to 6Ω. FIG. 24 is a schematic diagram showing a model of a miniaturized loop antenna in which the second inductor 27 is newly arranged in the miniaturized loop antenna shown in FIG. 16.

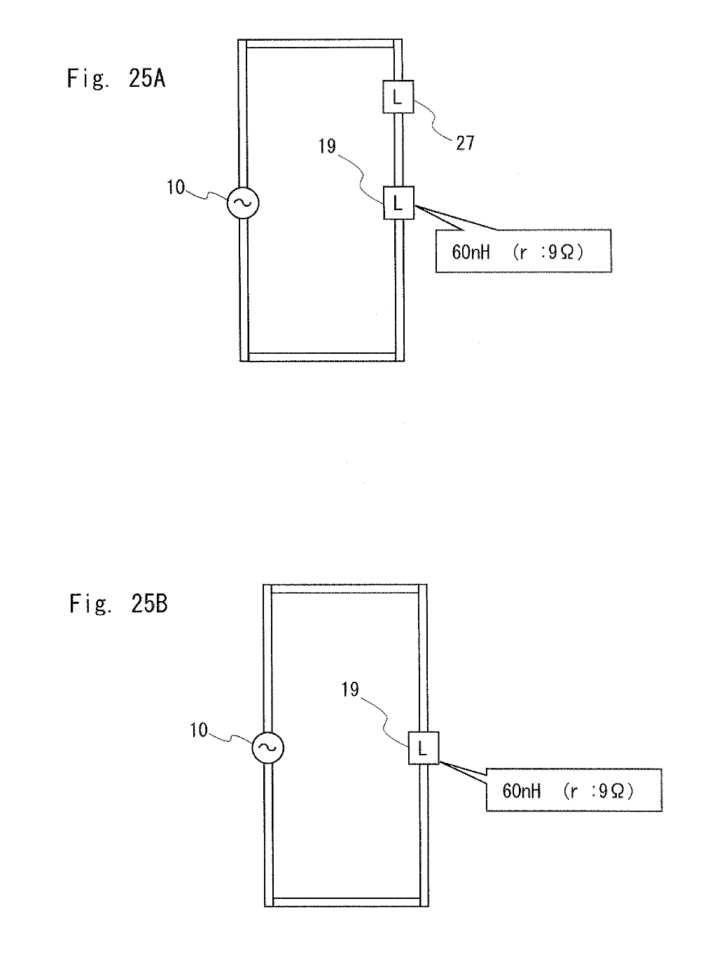

In the miniaturized loop antenna shown in FIG. 24, as shown in FIG. 25A, the second inductor 27 is arranged in one of the first and second low-density sections 25 and 26, in which the current intensity is low in the 1,760 MHz band, that is, in the section in which the impedance in the 1,760 MHz band is large. Thus, the state of the current distribution at 1,760 MHz hardly changes from the state shown in FIG. 22 even when the second inductor 27 is arranged.

FIG. 25 is a schematic diagram schematically showing, as a gray scale, intensities of currents as a result of simulating a distribution of the intensities of the currents in the 1,760 MHz band of the miniaturized loop antenna model shown in FIG. 24. FIG. 25A shows the state of the current distribution in the 1,760 MHz band after the second inductor 27 is newly arranged, and FIG. 25(B) shows the state of the current distribution (i.e., the state of the current distribution shown in FIG. 22) in the 1,760 MHz band prior to the arrangement of the second inductor 27.

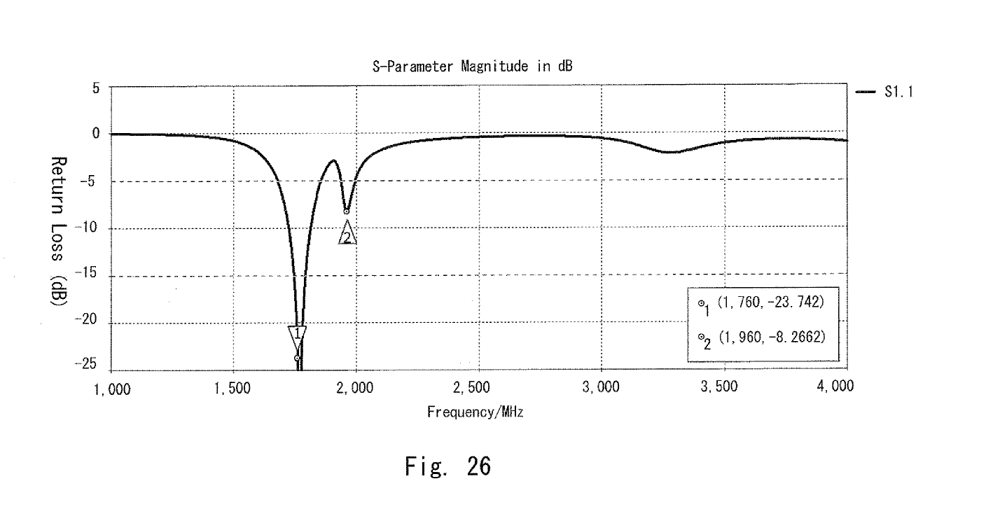

The model of the miniaturized loop antenna shown in FIG. 24 has a resonance frequency at about 1,760 MHz as indicated by the marker 1 on the graph of FIG. 26, as in the case of FIG. 17. In addition to this resonance frequency, the second resonance frequency of about 1,960 MHz is newly obtained as indicated by a marker 2, unlike the case of FIG. 17. FIG. 26 is a characteristic diagram showing the characteristics of the miniaturized loop antenna shown in FIG. 24, where the horizontal axis represents a frequency and the vertical axis represents a return loss.

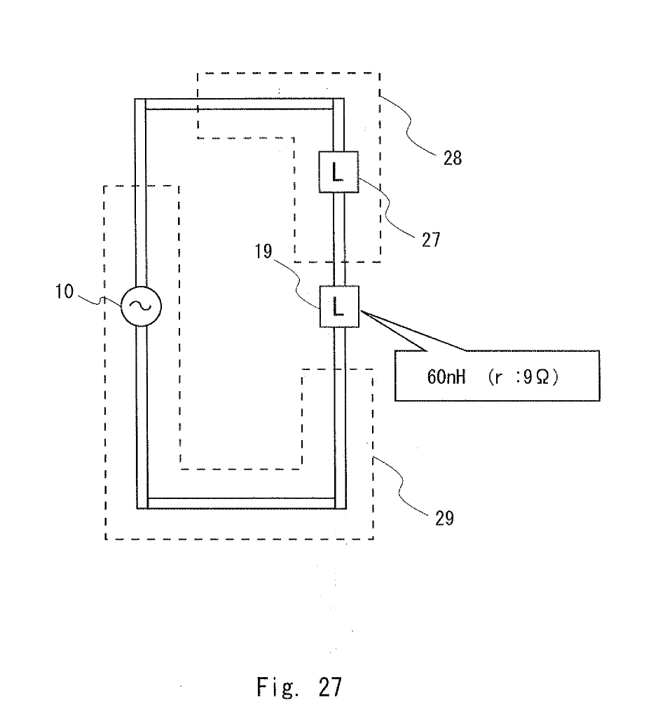

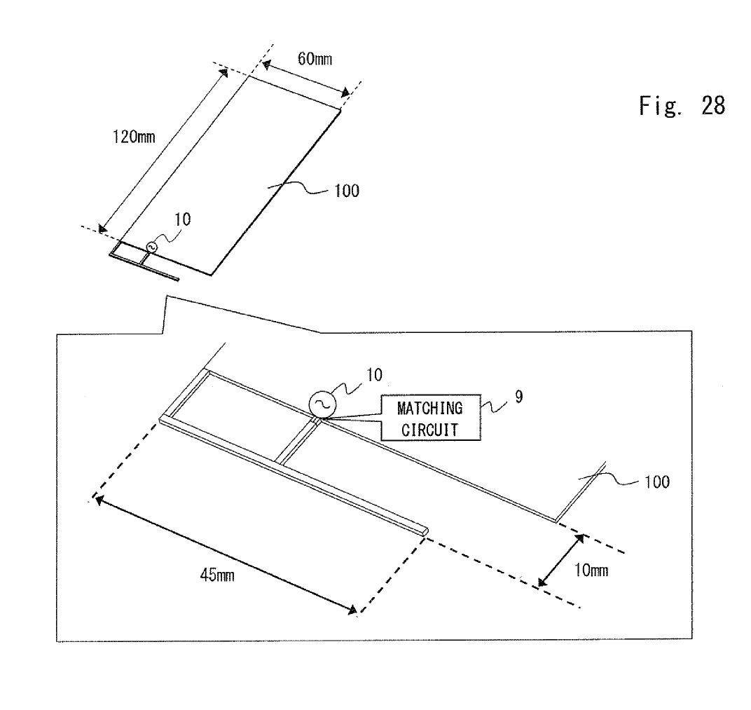

The schematic diagram of FIG. 27 shows the state of the current distribution at 1,960 MHz in which the second resonance frequency is newly obtained. FIG. 27 is a schematic diagram schematically showing, as a gray scale, intensities of currents as a result of simulating a distribution of the intensities of the currents in the 1,960 MHz band of the miniaturized loop antenna shown in FIG. 24. As shown in the schematic diagram shown in FIG. 27, it is apparent that in the current distribution in the 1,960 MHz band, the current intensity in the 1,960 MHz band is high in two sections of a high-density section 28, which is in the vicinity of the section in which the second inductor 27 is arranged, and a power-feed peripheral section 29, which is in the vicinity of the power feeding unit 10, and that the second inductor 27 generates a resonance in the 1,960 MHz band.

The principle of obtaining two resonances with two resonance frequencies in the miniaturized loop antenna has been described above. The operation of the multiband antenna according to the present invention using the principle will be described below.

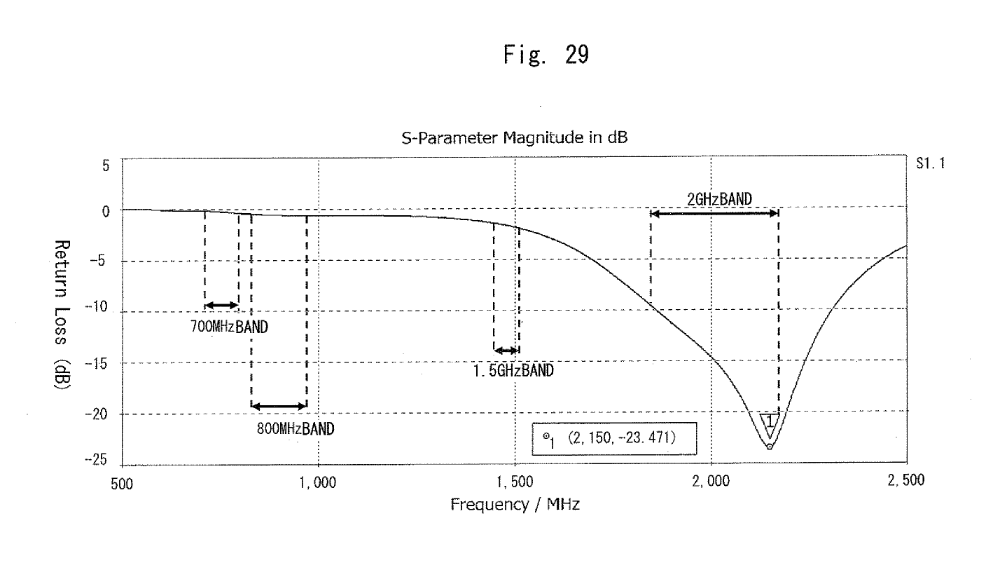

First, the shape of a general inverted F-shaped antenna will be described with reference to FIG. 28. FIG. 28 is a schematic diagram showing the shape of a model of a general inverted F-shaped antenna. The model of the general inverted F-shaped antenna shown in FIG. 28 shows the case where the substrate size is 120 mm×60 mm as shown in FIG. 2, the inverted F-shaped antenna is limited to the range of 10 mm×60 mm, and the antenna size is set to 10 mm×45 mm.

The model of the general inverted F-shaped antenna shown in FIG. 28 has a resonance point only at 2,150 MHz as indicated by the marker 1 on the graph of FIG. 29, and thus the antenna is a single-resonance antenna which does not have multiple resonance points. FIG. 29 is a characteristic diagram showing the characteristics of the general inverted F-shaped antenna shown in FIG. 28, where the horizontal axis represents a frequency and the vertical axis represents a return loss. In other words, the model of the general inverted F-shaped antenna shown in FIG. 28 has no resonance points in the 700 MHz band, the 800 MHz band, and the 1.5 GHz band, and has a resonance point only at 2,150 MHz in the 2 GHz band.

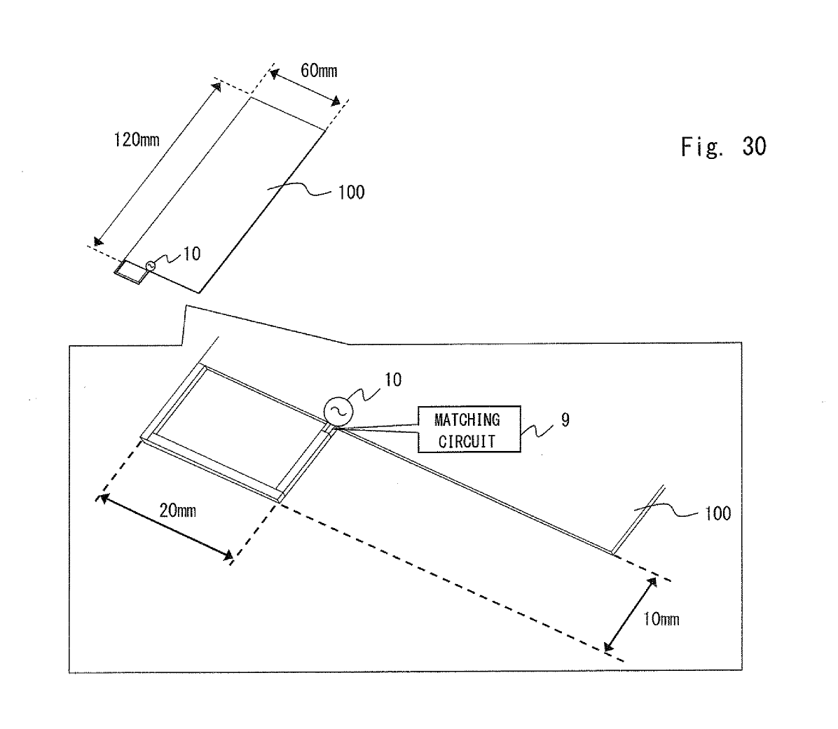

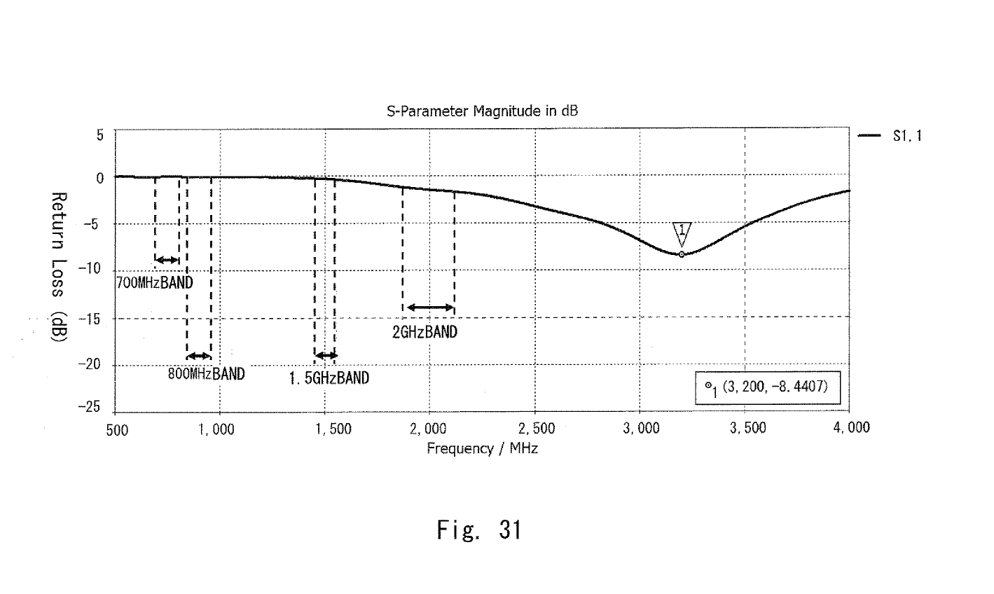

In contrast, FIG. 30 shows the shape of a loop antenna formed using only the loop portion of the model of the general inverted F-shaped antenna shown in FIG. 28. FIG. 30 is a schematic diagram showing the shape of the loop antenna formed using only the loop portion of the model of the general inverted F-shaped antenna shown in FIG. 28. The loop antenna shown in FIG. 30 is miniaturized to a size of 10 mm×20 mm as in the case of FIG. 2, and the model of the loop antenna has a resonance frequency at 3,200 MHz as shown in the graph of FIG. 31. FIG. 31 is a characteristic diagram showing the characteristics of the loop antenna shown in FIG. 30, where the horizontal axis represents a frequency and the vertical axis represents a return loss. Specifically, as shown in FIG. 31, the model of the loop antenna shown in FIG. 30 has no resonance points in any of the 700 MHz band, the 800 MHz band, the 1.5 GHz band, and the 2 GHz band, and has a resonance point only at 3,200 MHz.

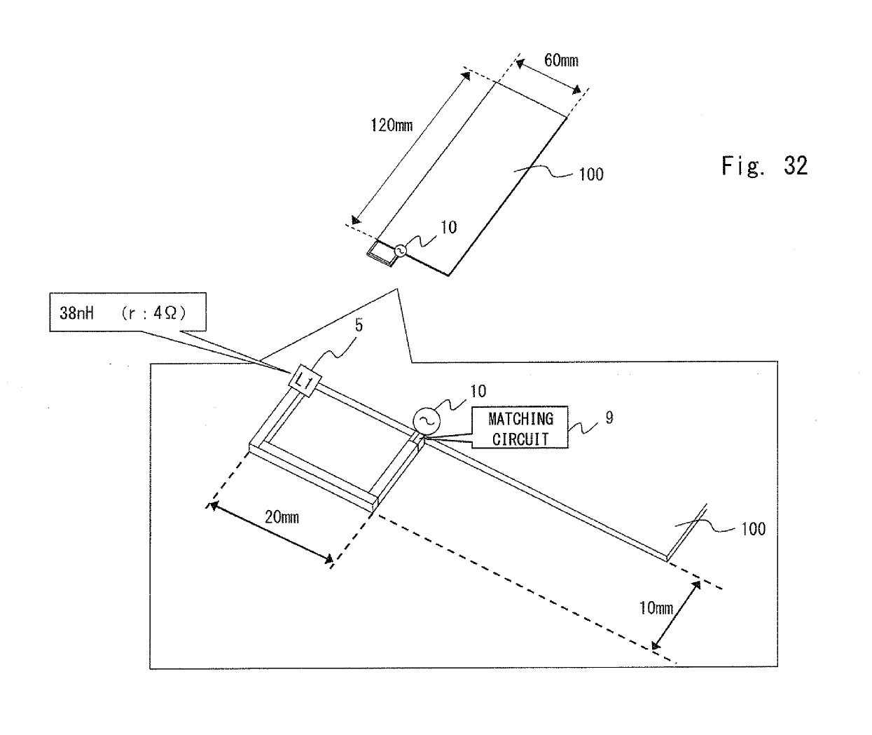

First, the first inductor 5 having the value of the inductance L1 is arranged in a section opposed to the power feeding unit 10 as shown in FIG. 32, so as to set the resonance frequency of the loop antenna shown in FIG. 30 (i.e., the portion corresponding to the loop portion of the inverted F-shaped antenna shown in FIG. 28) to match the 1.5 GHz band. FIG. 32 is a schematic diagram showing the state where the first inductor 5 is newly arranged in the loop antenna shown in FIG. 30. As shown in FIG. 32, the constant of the inductance L1 of the first inductor 5 is set to 38 nH, and an internal resistance r is set to 4Ω.

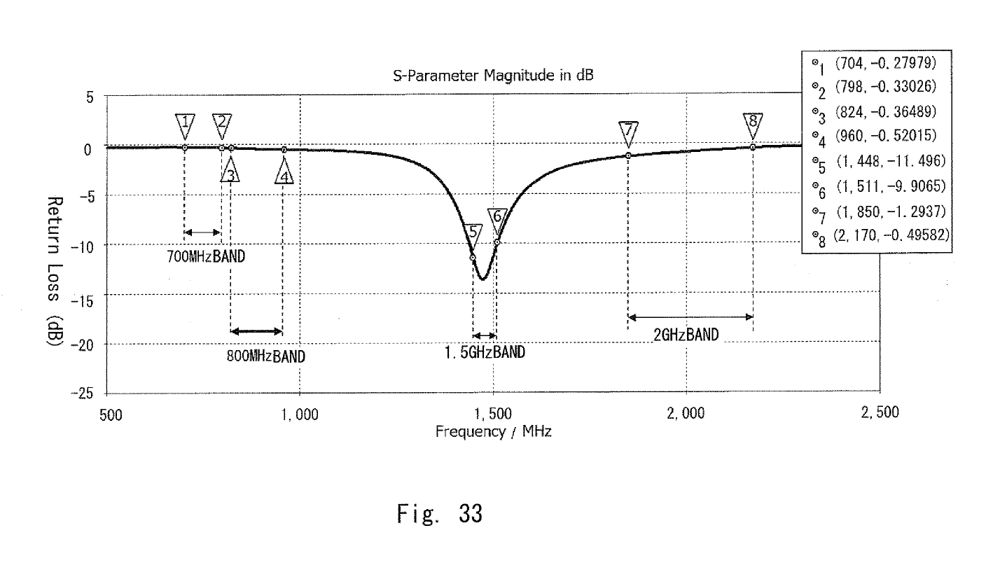

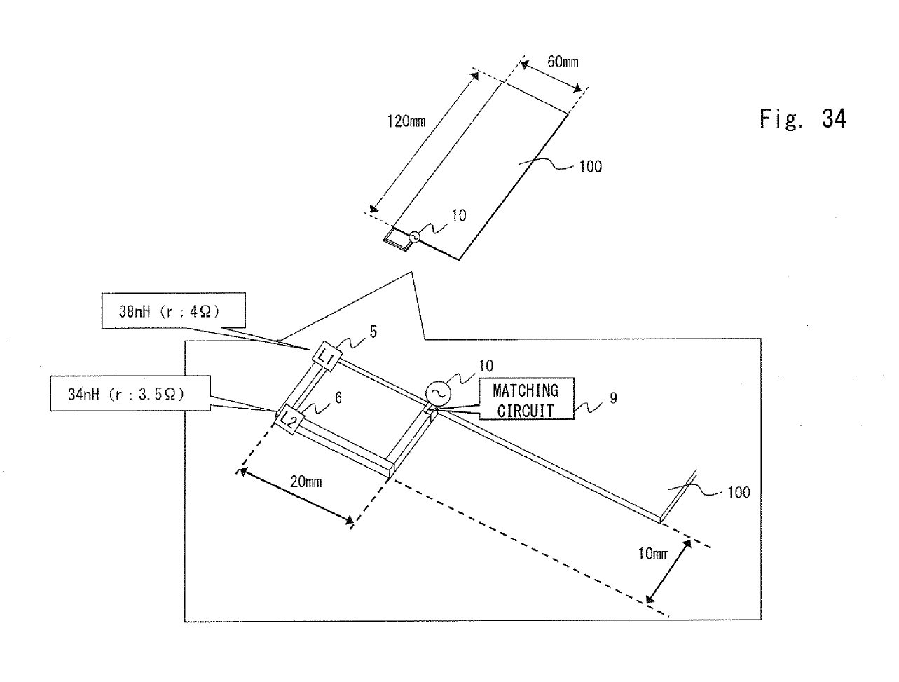

The arrangement of the first inductor 5 as shown in FIG. 32 makes it possible to obtain a resonance in the 1.5 GHz band indicated by markers 5 and 6 on the graph of FIG. 33. FIG. 33 is a characteristic diagram showing the characteristics of the loop antenna shown in FIG. 32, where the horizontal axis represents a frequency and the vertical axis represents a return loss. In other words, the model of the loop antenna shown in FIG. 32 has no resonance points in the 700 MHz band, the 800 MHz band, and the 2 GHz band, and has a resonance point in the 1.5 GHz band ranging from the marker 5 (1,448 MHz) to the marker 6 (1,511 MHz) as the frequency band of the 1.5 GHz band used for communication of mobile terminals.

Next, as shown in FIG. 34, the second inductor 6 having the value of the inductance L2 is additionally provided and arranged in the loop antenna shown in FIG. 32, so as to further obtain the second resonance point. FIG. 34 is a schematic diagram showing the state where the second inductor 6 is newly arranged in the loop antenna shown in FIG. 32. As described above with reference to FIG. 6, the second inductor 6 shown in FIG. 34 is arranged in the low-density section, in which the current intensity in the 1.5 GHz band is low, so as to prevent any adverse effect on the resonance operation in the 1.5 GHz band. As shown in FIG. 34, the constant having the value of the inductance L2 of the second inductor 6 is set to 34 nH, and the internal resistance r is set to 3.5Ω.

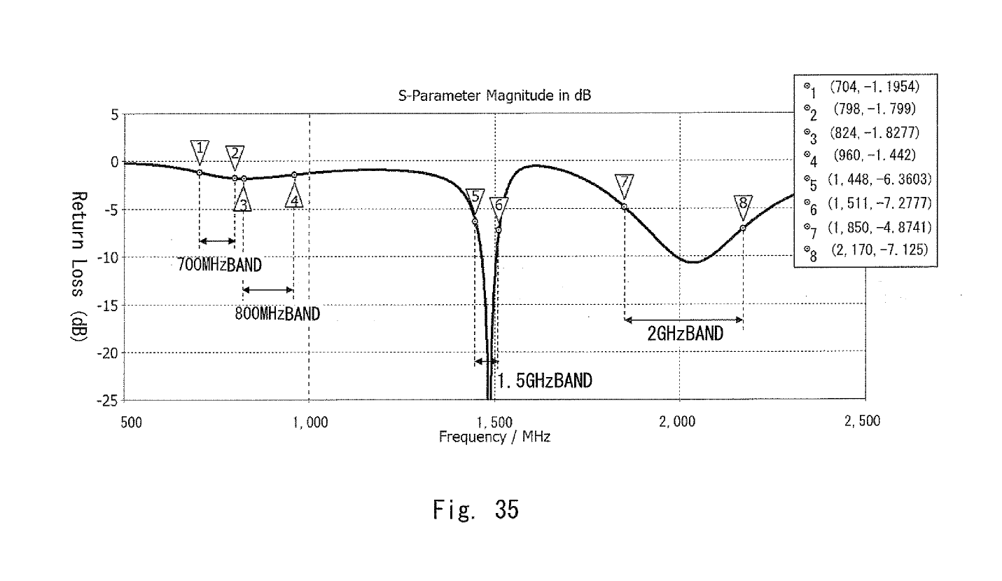

The second inductor 6 as shown in FIG. 34 is arranged in addition to the first inductor 5, thereby further obtaining a resonance point in the 2 GHz band indicated by markers 7 and 8 on the graph of FIG. 35 as the second resonance frequency, in addition to the resonance point in the 1.5 GHz band indicated by the markers 5 and 6 on the graph of FIG. 35. FIG. 35 is a characteristic diagram showing the characteristics of the loop antenna shown in FIG. 34, where the horizontal axis represents a frequency and the vertical axis represents a return loss. Specifically, as shown in FIG. 35, the model of the loop antenna shown in FIG. 34 has no resonance points in the 700 MHz band and the 800 MHz band, and has two resonance points in the 1.5 GHz band ranging from the marker 5 (1,448 MHz) to the marker 6 (1,511 MHz) and the 2 GHz band ranging from the marker 7 (1,850 MHz) to the marker 8 (2,170 MHz), which are the two bands of the 1.5 GHz band and the 2 GHz band on the high-frequency side used for communication of mobile terminals.

Further, as in the antenna shape shown in FIG. 2, at a node between the second antenna element 2 and the third antenna element 3, the third inductor 7 having the value of the inductance L3 and the capacitor 8 having the value of the capacitance C1 connected in parallel with the third inductor 7 are arranged, and the fourth antenna element 4 is arranged through the third inductor 7 and the capacitor 8. As a result of arranging the fourth antenna element 4 in this manner, the multiband antenna operating as a plurality of antennas such as the two-resonance loop antenna having two resonance points, the inverted F-shaped antenna formed of all the first to fourth antenna elements 1 to 4, and the inverted L-shaped antenna formed of the third and fourth antenna elements, can be formed.

In this case, the third inductor 7 having the value of the inductance L3 selects a predetermined value of, for example, 25 nH, as the value of the inductance L3, so as to obtain a high impedance at a high frequency, thereby preventing the high-frequency current flowing through the loop portion from flowing into the fourth antenna element 4. Accordingly, the two-resonance loop antenna having two resonance points resonates in a high-frequency band, and the fourth antenna element 4 resonates in a low-frequency band. At this time, the fourth antenna element 4 operates as the inverted F-shaped antenna formed of the four antenna elements, i.e., the first to fourth antenna elements 1 to 4, and also operates as the inverted L-shaped antenna formed of the third and fourth antenna elements 3 and 4, thereby making it possible to generate two resonance points, i.e., third and fourth resonance points at which resonances can be obtained in the low-frequency band.

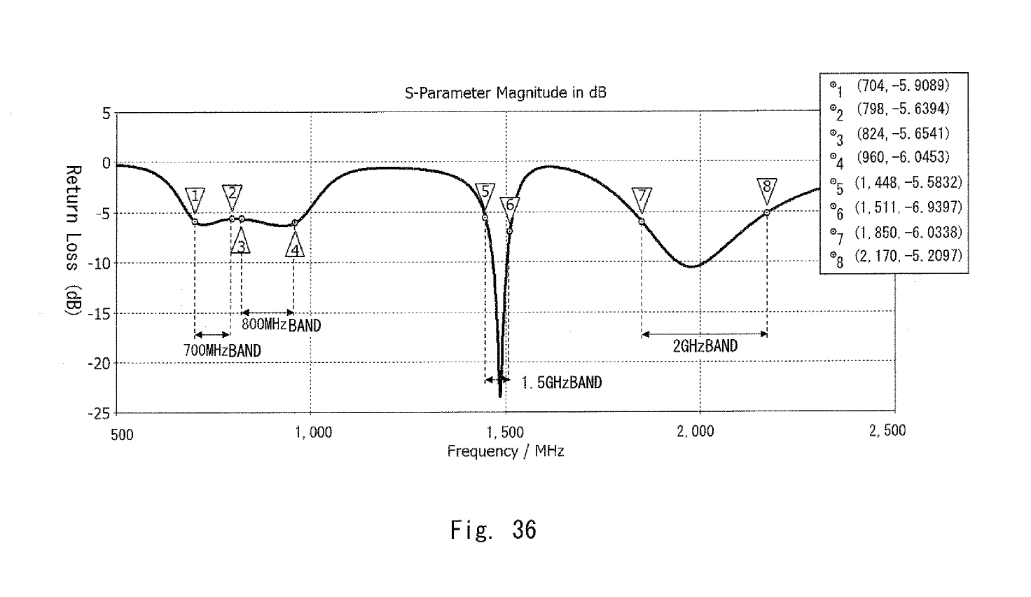

In other words, the third inductor 7 and the fourth antenna element 4 as shown in FIG. 2 are added and arranged in the loop antenna shown in FIG. 34, thereby obtaining, as third and fourth resonance frequencies, two resonance points of a resonance point in the 700 MHz band indicated by the markers 1 and 2 on the graph of FIG. 36 and a resonance point in the 800 MHz band indicated by markers 3 and 4, in addition to the two resonance points in the 1.5 GHz indicated by the markers 5 and 6 and the 2 GHz band indicated by the markers 7 and 8 on the graph of FIG. 36. FIG. 36 is a characteristic diagram showing the characteristics of the multiband antenna shown in FIG. 2 which has a configuration in which the third inductor 7, the capacitor 8, and the fourth antenna element 4 are added in the loop antenna shown in FIG. 34. In FIG. 36, the horizontal axis represents a frequency and the vertical axis represents a return loss. Specifically, as shown in FIG. 36, the model of the multiband antenna shown in FIG. 2 has four resonance points in four bands used for communication of mobile terminals, that is, in the 700 MHz band ranging from the marker 1 (704 MHz) to the marker 2 (798 MHz), the 800 MHz band ranging from the marker 3 (824 MHz) to the marker 4 (960 MHz), the 1.5 GHz band ranging from the marker 5 (1,448 MHz) to the marker 6 (1,511 MHz), and the 2 GHz band ranging from the marker 7 (1,850 MHz) to the marker 8 (2,170 MHz).

As described in detail above, the multiband antenna according to this exemplary embodiment has the configuration in which the four miniaturized antenna elements, i.e., the first to fourth antenna elements 1 to 4, and at least three inductors, i.e., the first to third inductors, are arranged, thereby achieving a broadband antenna that covers four bands, even when the antenna has a shape similar to that of the inverted F-shaped antenna that can generally obtain only a single resonance.

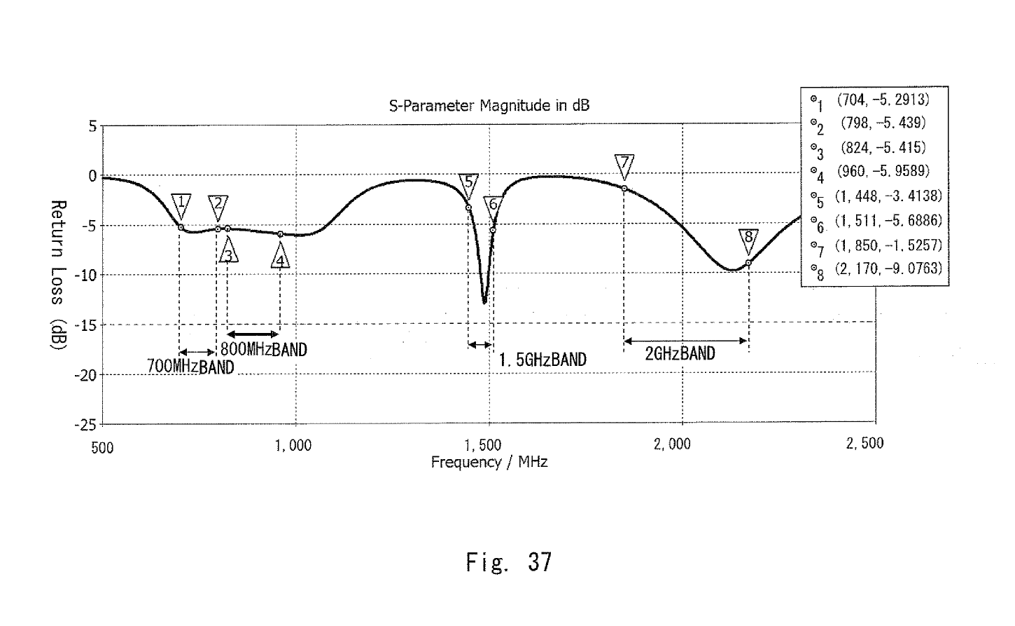

Note that the model of the multiband antenna shown in FIG. 2 shows the case where the capacitor 8 having the value of the capacitance C1 (0.25 pF) is arranged in parallel with the third inductor 7 having the value of the inductance L3. However, when the capacitor 8 which has the value of the capacitance C1 and is arranged in parallel with the third inductor 7 is not present, a deviation of the resonance frequencies may occur as shown in FIG. 37. FIG. 37 is a characteristic diagram showing the characteristics of the multiband antenna shown in FIG. 2, from which the capacitor 8 having the value of the capacitance C1 is removed. In FIG. 37, the horizontal axis represents a frequency and the vertical axis represents a return loss. As shown in FIG. 37, when the capacitor 8 which has the value of the capacitance C1 and is arranged in parallel with the third inductor 7 is not present, the deviation of the four resonance frequencies occurs, unlike in the case shown in FIG. 36.

Particularly, in regard to the deviation of the antenna characteristics shown in FIG. 37, it is a problem that a characteristic deterioration point between the 800 MHz band and the 1.5 GHz band deviates to the side of the 1.5 GHz band. The arrangement of the capacitor 8 having the value of the capacitance C1 has an advantage of facilitating the adjustment of the characteristic deterioration point to a frequency between the 800 MHz band and the 1.5 GHz band. However, the above-mentioned characteristic deterioration point can also be adjusted by carefully selecting antenna elements or constants of other parts, instead of arranging the capacitor 8. Therefore, in the present invention, the capacitor 8 having the value of the capacitance C1 is not an essential component.

### Other Exemplary Embodiments

The exemplary embodiments described above illustrate the case of forming the multiband antenna for four resonances which resonates the four bands of the 700 MHz band, the 800 MHz band, the 1.5 GHz band, and the 2 GHz band, which are frequencies for mobile terminal communication. However, the present invention is not limited to these frequencies, and can be applied to other frequencies.

For example, not only the above-mentioned antennas for use in voice or data communications, but also antennas such as a GPS (Global Positioning System), Bluetooth, and wireless LAN (Local Area Network) are incorporated in mobile terminals. The present invention can also be applied to antennas used for purposes other than voice or data communications.

To miniaturize a device, any one of GPS, Bluetooth, and wireless LAN antennas is used as a shared antenna in many cases. In such a case, since the Bluetooth and wireless LAN use the same frequency band as 2.4 GHz, for example, three applications of the GPS, Bluetooth, and wireless LAN can be covered by adopting a two-resonance antenna that covers a 1575.42 MHz band and a 2.4 GHz band of the GPS.

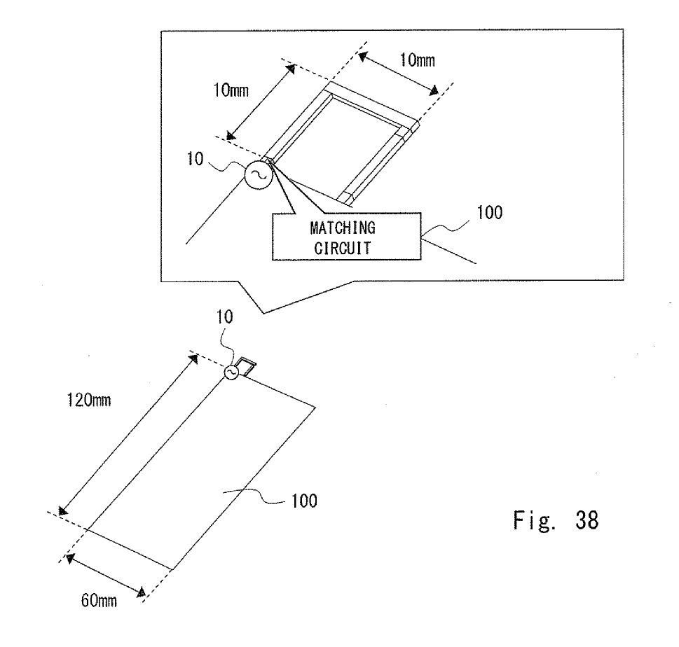

The two-resonance antenna that covers the 1575.42 MHz band and the 2.4 GHz band of the GPS can be achieved with, for example, a miniaturized antenna size of 10 mm×10 mm as shown in the schematic diagram of FIG. 38. FIG. 38 is a schematic diagram showing the shape of the two-resonance antenna that covers the 1,575.42 MHz band and the 2.4 GHz band. The two-resonance antenna is formed as a loop antenna having two resonance points.

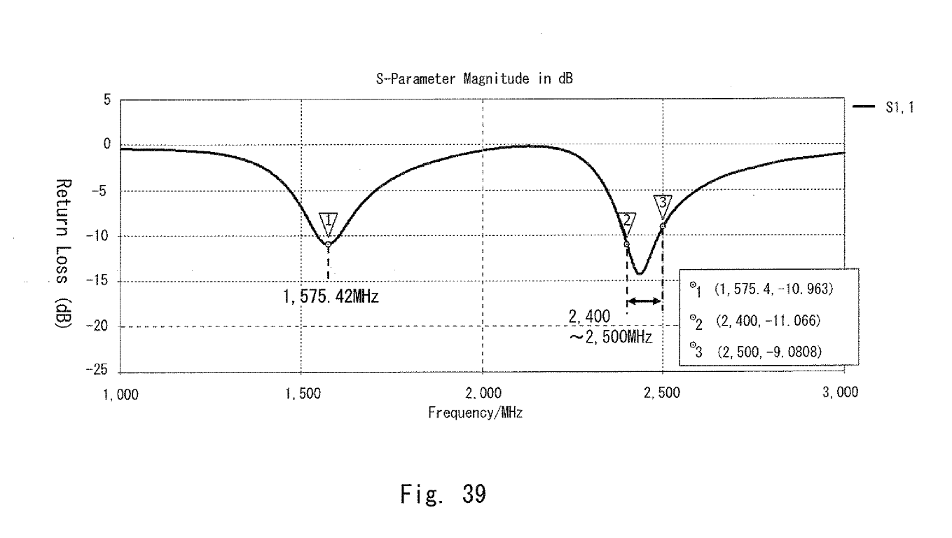

The formation of the loop antenna shown in FIG. 38 makes it possible to obtain the two-resonance antenna having two resonance points in the 1,575.42 MHz band indicated by the marker 1 on the graph of FIG. 39 and the 2.4 GHz band ranging from the marker 2 (2,400 MHz) to the marker 3 (2,500 MHz). FIG. 39 is a characteristic diagram showing the characteristics of the loop antenna shown in FIG. 38, where the horizontal axis represents a frequency and the vertical axis represents a return loss.

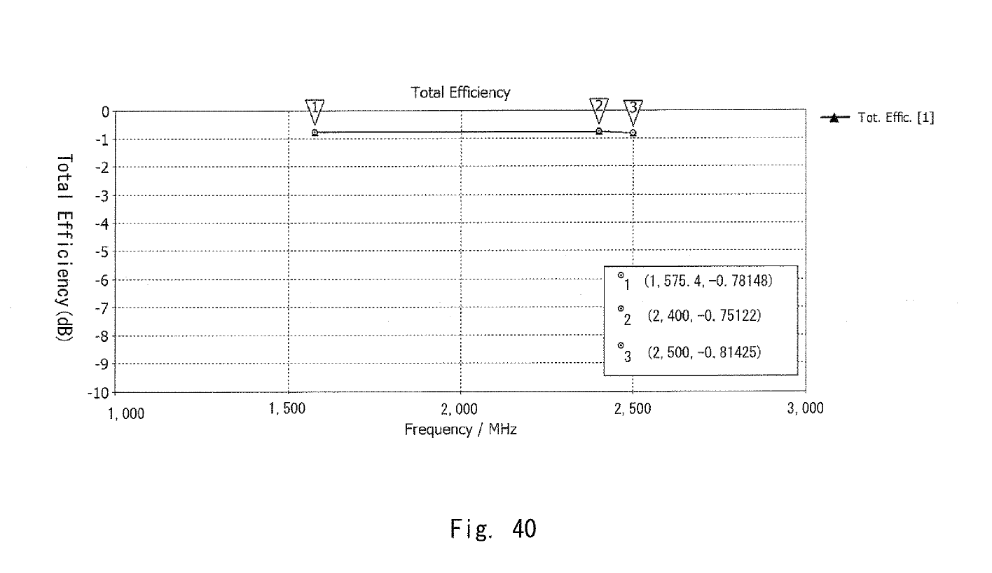

With the loop antenna shown in FIG. 38, the two-resonance antenna having the antenna characteristics shown in FIG. 39 can be reliably achieved. Further, since an extremely satisfactory characteristic of −1 dB or more is obtained as the antenna efficiency shown in FIG. 40, the antenna size of 10×10 mm can be further reduced. FIG. 40 is a characteristic diagram showing results obtained by calculating the antenna efficiency of the loop antenna shown in FIG. 38 by the electromagnetic field simulator. Note that the antenna efficiency shown in FIG. 40 is represented by Total Efficiency. The Rad. Efficiency (Radiation Efficiency) representing the above-mentioned antenna efficiency in FIG. 20 is used to compare only the antenna characteristics after a matching loss generated from the difference between a feeding point and an antenna impedance is corrected, whereas Total Efficiency shown in FIG. 40 includes a matching loss between the feeding point and the antenna impedance and represents the characteristics of the entire device in which the antenna is mounted.

### Description of Effects of Exemplary Embodiment

As described in detail above, the multiband antenna according to this exemplary embodiment provides the following effects.

A first effect is that the mobile terminal that incorporates the multiband antenna can be significantly miniaturized. This is because a plurality of resonances, for example, four resonances, can be obtained by an antenna having the same size as a single-resonance antenna incorporated in a general mobile terminal, and thus the antenna can cover multiple bands without increasing the antenna size and the number of antennas.

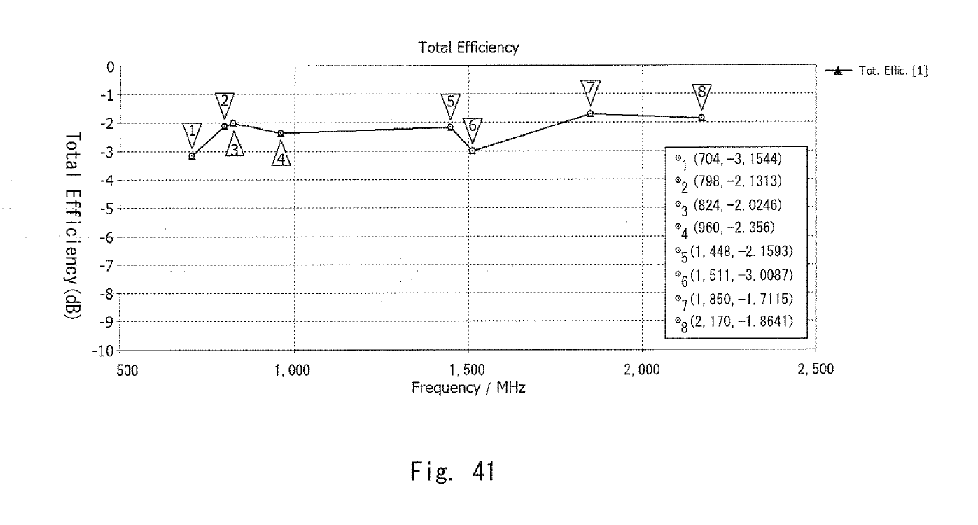

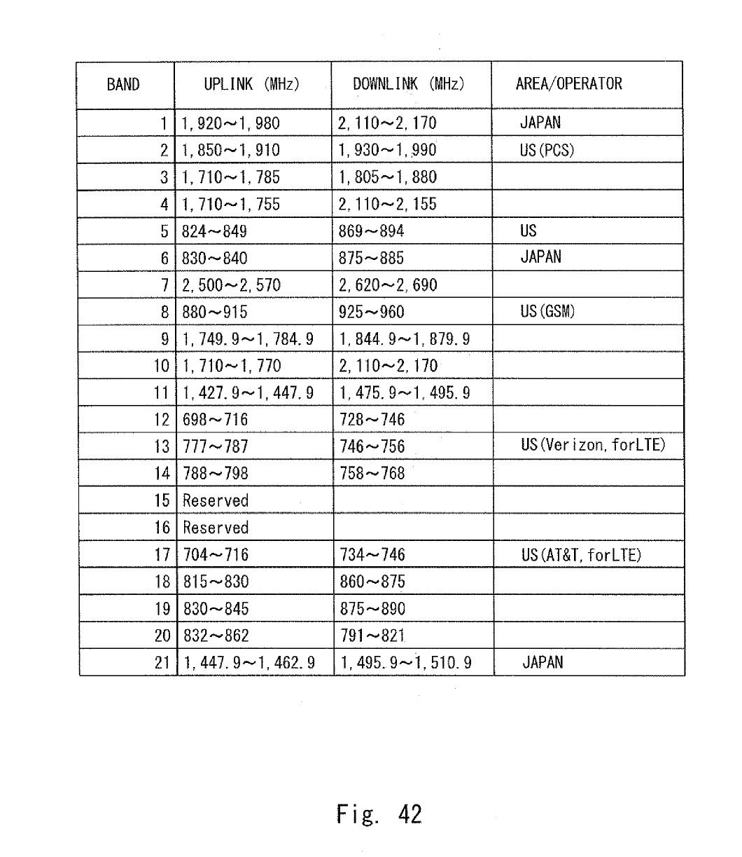

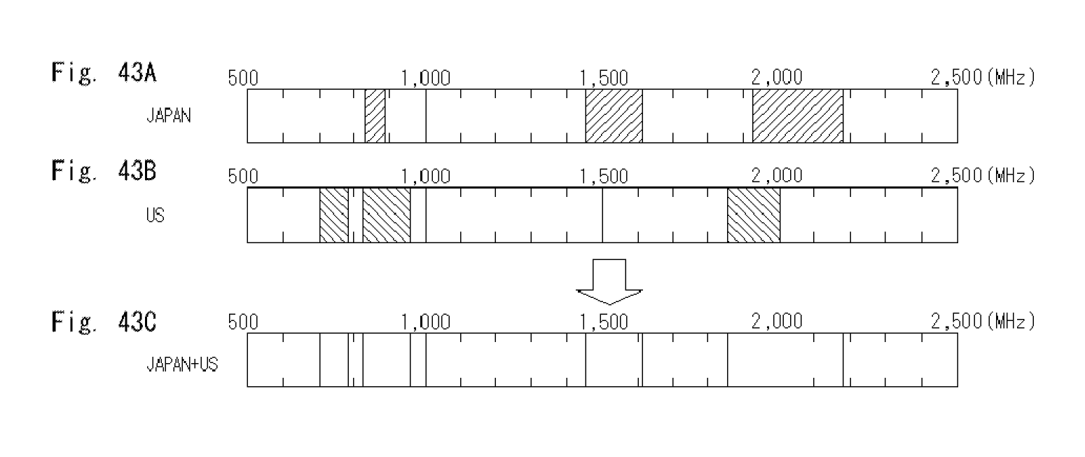

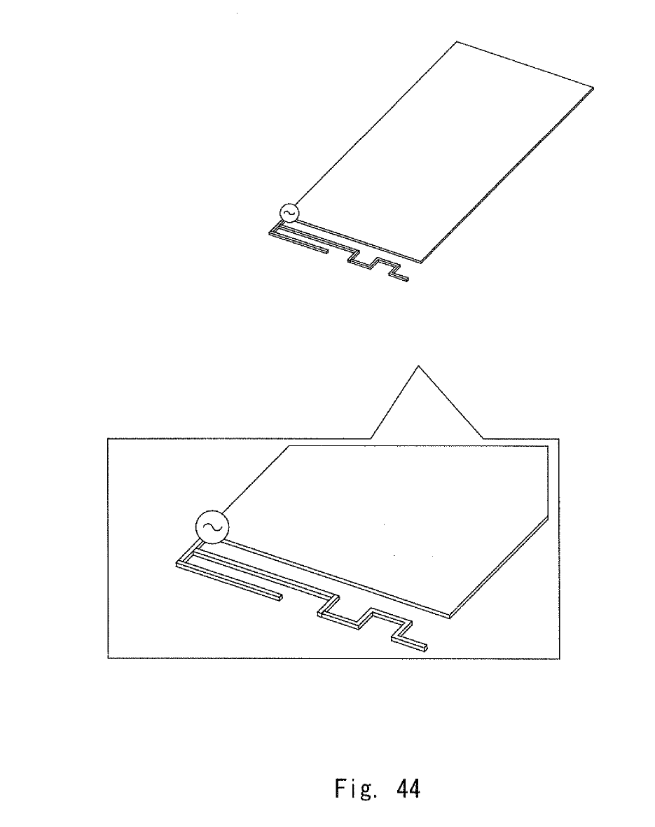

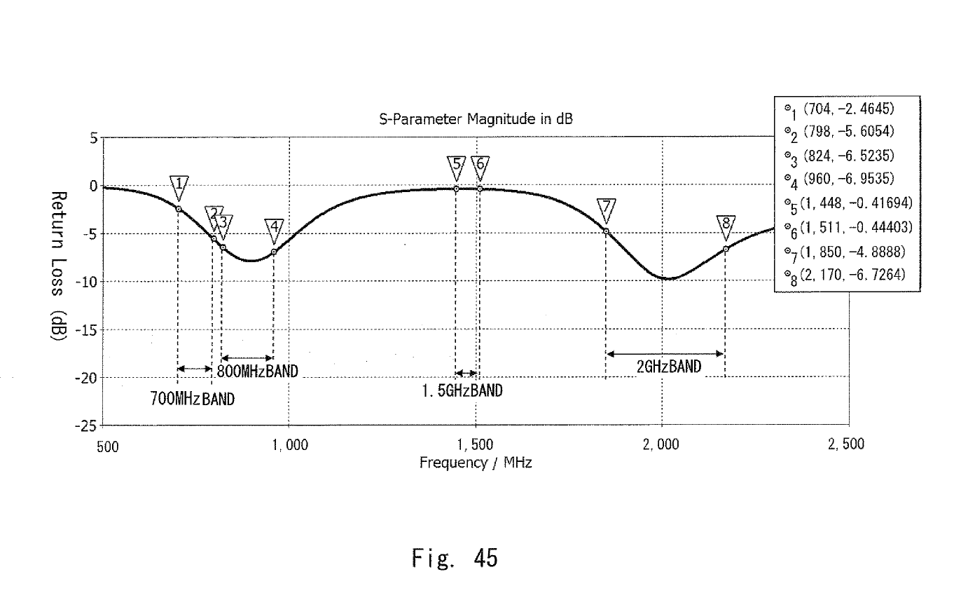

The characteristics of antennas covering multiple bands deteriorate in many cases due to the interference between antenna elements, for example. On the other hand, in the case of the antenna of this exemplary embodiment, a satisfactory antenna efficiency of about −3 dB or more can be obtained across the entire frequency band as shown in the characteristic diagram of FIG. 41. FIG. 41 is a characteristic diagram showing results obtained by calculating the antenna efficiency of the model of the multiband antenna shown in FIG. 2 by the electromagnetic field simulator. Unlike the Rad. Efficiency which represents the antenna efficiency described above with reference to FIG. 20, the antenna efficiency shown in FIG. 41, which is represented by Total Efficiency, includes a matching loss between a feeding point and an antenna impedance and represents the characteristics of the entire device mounted with the antenna, as in the case of FIG. 40.

Many general mobile terminals are used with an antenna efficiency of about −3 to −5 dB. Accordingly, when the antenna efficiency is equal to or larger than −3 dB as shown in FIG. 41, a mobile terminal having satisfactory antenna characteristics can be achieved.

A second effect is that the cost of the mobile terminal mounted with the multiband antenna can be significantly reduced. This is because the multiband antenna of this exemplary embodiment can be achieved merely by adding three chip parts (three inductors, i.e., the first to third inductors 5 to 7), or in some cases, four chip parts (three inductors, i.e., the first to third inductors 5 to 7, and the capacitor 8), to the miniaturized antenna elements, in the case of the four-resonance antenna. Thus, a much more inexpensive device can be designed, as compared with the case of adopting an antenna which needs to incorporate an additional antenna element, or a complicated configuration.

The configurations of preferred embodiments of the present invention have been described above. However, it should be noted that the exemplary embodiments described above are merely illustrative of the present invention and are not intended to limit the present invention. Those skilled in the art can easily understand that the present invention can be changed or modified in various manners depending on specific purposes, without departing from the scope of the invention.

The present application claims priority rights of and is based on Japanese Patent Application No. 2011-254754 filed on Nov. 22, 2011 in the Japanese Patent Office, the entire contents of which are hereby incorporated by reference.

### INDUSTRIAL APPLICABILITY

The present invention is applicable to an antenna for a communication device which performs wireless communications.

### REFERENCE SIGNS LIST

1 FIRST ANTENNA ELEMENT
2 SECOND ANTENNA ELEMENT
3 THIRD ANTENNA ELEMENT
4 FOURTH ANTENNA ELEMENT
5 FIRST INDUCTOR
6 SECOND INDUCTOR
7 THIRD INDUCTOR
8 CAPACITOR
9 MATCHING CIRCUIT
10 POWER FEEDING UNIT
11 GND GROUND POINT
12 POWER-FEED PERIPHERAL PORTION
13 HIGH-DENSITY SECTION
14 LOW-DENSITY SECTION
15 HIGH-DENSITY SECTION
16 IMPEDANCE
17 POWER-FEED PERIPHERAL SECTION
18 HIGH-DENSITY SECTION
19 INDUCTOR
20 INDUCTOR
21 FIRST DIPOLE ANTENNA
22 SECOND DIPOLE ANTENNA
23 POWER-FEED PERIPHERAL SECTION
24 HIGH-DENSITY SECTION
25 FIRST LOW-DENSITY SECTION
26 SECOND LOW-DENSITY SECTION
27 SECOND INDUCTOR
28 HIGH-DENSITY SECTION
29 POWER-FEED PERIPHERAL SECTION
100 SUBSTRATE

1. A multiband antenna having a plurality of resonance frequencies, the multiband antenna comprising:
a two-resonance loop antenna capable of resonating at two resonance frequencies of a first resonance frequency and a second resonance frequency on a high-frequency side of resonance frequencies, by adding, connecting, and arranging a first inductor and a second inductor to a loop antenna formed of miniaturized antenna elements with an element length shorter than that of each wavelength of the resonance frequencies.

2. The multiband antenna according to claim 1, wherein the first resonance frequency can be set to a given frequency by adjusting an inductance value of the first inductor, and the second resonance frequency can be set to a given frequency by adjusting an inductance value of the second inductor.

3. The multiband antenna according to claim 1, wherein
the first inductor is arranged in a section with a high current intensity at the first resonance frequency, the section being opposed to a power feeding unit of the two-resonance loop antenna, and
the second inductor is arranged in a section with a low current intensity at the first resonance frequency, the section being opposed to the power feeding unit of the two-resonance loop antenna.

4. The multiband antenna according to claim 1, wherein an additional antenna element is further connected and arranged to the two-resonance loop antenna through a third inductor, thereby forming a four-resonance antenna capable of operating not only as the two-resonance loop antenna but also as an inverted F-shaped antenna and an inverted L-shaped antenna and capable of resonating not only at the first and second resonance frequencies but also at third and fourth resonance frequencies on a low-frequency side.

5. The multiband antenna according to claim 4, wherein an inductance value of the third inductor is set to an impedance value to prevent a high-frequency current flowing through the two-resonance loop antenna from flowing into the additional antenna element.

6. The multiband antenna according to claim 4, wherein a capacitor for frequency adjustment is connected and arranged in parallel with the third inductor.

7. A mobile terminal mounted with an antenna that covers multiple bands, the antenna comprising a multiband antenna according to claim 1.

8. The multiband antenna according to claim 5, wherein a capacitor for frequency adjustment is connected and arranged in parallel with the third inductor.
